(19) United States
(12) Patent Application Publication
(10) Pub. No.: US 2007/0074145 A1
(43) Pub. Date: Mar. 29, 2007

(54) Mask pattern design method and manufacturing method of semiconductor device

(75) Inventor: Toshihiko Tanaka, Tokyo (JP)

Correspondence Address: Stanley P. Fisher;Reed Smith LLP, Suite 1400, 3110 Fairview Park Drive, Falls Church, VA, 22042-4503, US

(73) Assignee: Renesas Technology Corp.

(21) Appl. No.: 11/505,870

(22) Filed: Aug. 18, 2006

(30) Foreign Application Priority Data
Sep. 28, 2005 (JP) JP2005-281503

(51) Int. Cl. G06F 17/50

(52) U.S. Cl. 716/21; 716/8

(57) ABSTRACT

To a cell library pattern which makes the basic constitution of a semiconductor circuit pattern, OPC processing is performed beforehand, and a semiconductor chip is produced using this cell library pattern. Since it is influenced by the pattern of the cell arranged to the circumference and the pattern arranged around other cells at this time, correction processing (optimization processing) is performed. The part of this correction processing is a portion in which a pattern faces between cell boundaries in the inside of the region specified from the cell boundary, and proximity effect correction is performed by making the width, the length, and the position of this portion into variables. Or proximity effect correction is performed by making a polygon into a variable. Or sizing is done and proximity effect correction is performed.

### CROSS-REFERENCE TO RELATED APPLICATION

The present application claims priority from Japanese patent application No. 2005-281503 filed on Sep. 28, 2005, the content of which is hereby incorporated by reference into this application.

### TECHNICAL FIELD OF THE INVENTION

The present invention relates to manufacturing technology of a semiconductor device, and particularly relates to an effective technology in the application to the mask pattern design step for forming a pattern smaller than the exposure wavelength of optical lithography.

### BACKGROUND OF THE INVENTION

A semiconductor device is mass-produced by repeating and using the optical lithography step which irradiates exposing light to the mask which is the original plate with which the circuit pattern was drawn, and transfers the pattern on a semiconductor substrate (hereafter called “wafer”) via a reduction optical system. The microfabrication of a semiconductor device progresses in recent years, and formation of the pattern which has a size smaller than the exposure wavelength of optical lithography has been needed. However, in the pattern transfer of such a fine area, the influence of the diffraction of light appears notably, and the outline of a mask pattern is not formed on a wafer as it is, but the corner part of a pattern becomes round, length becomes short, or accuracy of form deteriorates substantially. Then, processing which reverse-corrects mask pattern shape is performed, and a mask pattern is designed so that this degradation may become small. This processing is called as light proximity effect correction (hereafter called as Optical Proximity Correction; “OPC”).

Conventional OPC is performing correction with a rule base, or the model base using an optical simulation in consideration of the form, and the surrounding influence of a pattern for every figure of a mask pattern. Rule base OPC which performs pattern correction by doing figure operation according to line width and the adjoining space width is described in Patent Reference 3 (Japanese Unexamined Laid-open Patent Publication No. 2002-303964). Rule base OPC which performs line segment vectorization processing and line segment sorting application, performs calculation of line width and space width, and performs pattern correction with reference to the compensation table using a hash function is described in Patent Reference 2 (Japanese Unexamined Laid-open Patent Publication No. 2001-281836). In Patent Reference 4 (Japanese Unexamined Laid-open Patent Publication No. 2004-61720), model base OPC which incorporated the process effect by transfer experiment is described.

With the model base using an optical simulator, a mask pattern is changed until it obtains a desired transfer pattern, but various methods are proposed depending on the way of driving in. There are the method that, for example the part is dwindled if the optical image has swollen partially, it is made to grow fat that much if it has become thin, and it is driven in gradually recalculating an optical image in the state, the so-called serial improving method, etc. The method of driving in using genetic algorithm is also proposed. In the method using genetic algorithm, a pattern is divided into a plurality of line segments, and displacement of those line segments is assigned as a displacement code. It is the method of calculating hereditary evolution by considering that a displacement code is a chromosome, and driving into a desired optical image. The optimization technology of OPC using this genetic algorithm is described in Patent Reference 1 (Japanese Patent Publication No. 3512954).

In Patent Reference 5 (Japanese Unexamined Laid-open Patent Publication No. 2002-328457), the system which changes a figure not for the whole mask layout but for every portion is described. As the procedure, the environmental profile expressed in the specific form is first determined according to whether other figures exist in the circumference of the object cell about each of the object-of-amendment cell included in design layout data. And with reference to a cell substitution table, the replacement cell name which is a name of the correction pattern which should be replaced corresponding to the determined environmental profile is read, and after-correction layout data is generated. Finally, the correction pattern corresponding to the read replacement cell name is incorporated from a cell library, and the mask data of which the correction is completed are generated.

### SUMMARY OF THE INVENTION

By the way, the following became clear as a result of an examination for the above mask pattern design technology by the inventor of the present invention.

For example, in the system of Patent Reference 5, about environmental profiles, and about all of the object-of-amendment cell which can be assumed, the optimal correction pattern that should be replaced must be determined, a replacement cell name must be given to each correction pattern, the environmental profile and a replacement cell name must be associated, and stored in a cell substitution table beforehand. Therefore, there are problems that the cost necessary for advanced preparations is large and many storage areas are needed.

Genetic algorithm (Genetic Algorithm; hereafter called as “GA”) is the search technique used as the population genetics model, and the excellent performance which can show high optimization performance without being dependent on the target problem is known. As a reference of GA, there is above-mentioned Non-patent Literature 1, for example.

In GA, the solution candidate of search problems is expressed by the bit row called a chromosome, and it is made to struggle for existence by performing character row operation to the group which includes a plurality of chromosomes. Each chromosome is estimated by the objective function which is the search problems in themselves, and the result is calculated as fitness which is a scalar value. An opportunity to leave many posterity is given to a chromosome with high fitness. A new chromosome is generated by crossing-over in the chromosomes within a group and giving mutation. By repeating such processing, a chromosome with higher fitness is generated and the highest chromosome of fitness constitutes a final solution.

FIG. 1 is a flow chart in which the most fundamental computational procedure of GA (Step s01) is shown. The purpose and outline of each processing are as follows.

Initialization (Step S02): Generate a plurality of chromosomes as a solution candidate at random, and form a group. The optimization problem which should be solved is expressed as an evaluation function which returns a scalar value.

Evaluation of Chromosome (Step S03): Evaluate a chromosome using an evaluation function and calculate the fitness of each chromosome.

Generation of Next-generation group (Step S04): Give the opportunity which can leave many posterity as a chromosome with high fitness using hereditary operation (selection, crossing-over, mutation).

Termination Standard Judging of Search (Step S05): Repeat Evaluation of Chromosome, and Formation of Next-generation group until the conditions given beforehand are satisfied.

Hereafter, the outline of genetic algorithm is shown based on FIG. 1.

In “Initialization” of Step S02, “Definition of Chromosome Expression”, “Determination of Evaluation Function”, and “Generation of Initial-chromosomes group” are performed.

In “Definition of Chromosome Expression”, it is defined that the data in what kind of contents and form is transmitted to posterity's chromosome from parents' chromosome in the case of an alternation of generations. A chromosome is exemplified in FIG. 2. Here, each element xᵢ (i=1, 2, . . . , D) of variable vector X=(x₁, x₂, . . . , x_{D}) of D dimension expressing the point of the solution space of the target optimization problem will be expressed with the row of M symbols Aᵢ (i=1, 2, . . . , M), and it is considered that this is a chromosome which includes genes of D×M individuals. As value Ai of a gene, the group of a certain integer, the real value of a certain range, a symbol r o w, etc. are used according to the character of the problem which should be solved. FIG. 2 is an example when each valuable is expressed by using four-piece (namely, M=4) of two kinds of symbols {0, 1}, about one of the solution candidates of the optimization problem of 5-dimensional, i.e., 5 variables (namely, D=5). The gene row symbolized in this way is a chromosome.

Next, in “Determination of Evaluation Function”, the calculation method of the fitness showing how much or extent each chromosome fits environment is defined. In this case, it is designed so that the fitness of the chromosome corresponding to the variable vector which is excellent as a solution of the optimization problem which should be solved may become high.

In “Generation of Initial-chromosomes group”, N chromosomes are usually generated at random according to the rule decided by “Definition of Chromosome Expression.” This is because the characteristic of the optimization problem which should be solved is unknown and it is completely unknown what kind of chromosome is excellent. However, when there is a certain foresight knowledge regarding a problem, search speed and accuracy may be able to be improved by generating a chromosome group centering on the area predicted that fitness is high in solution space.

In “Evaluation of Chromosome” of Step S03, the fitness of each chromosome in a group is calculated based on the method defined in the above “Determination of Evaluation Function.”

In “Next-generation group's Formation” of Step S04, based on the fitness of each chromosome, hereditary operation is performed to a chromosome group and a next-generation chromosome group is generated. As a typical procedure of hereditary operation, there are selection, crossing-over, mutation, etc. and these are generically called hereditary operation.

In “Selection”, processing which extracts a chromosome with high fitness from a current generation's chromosome group, leaves a next-generation group, and removes a chromosome with low fitness conversely is performed.

In “Crossing-over”, operation which makes a new chromosome by choosing a chromosome pair at random with predetermined probability out of the chromosome group extracted by selection, and rearranging a part of those genes is performed.

In “Mutation”, out of the chromosome group extracted by selection, a chromosome is chosen at random with predetermined probability, and a gene is changed with predetermined probability. Here, the probability that mutation will occur is called a mutation rate.

In “Termination Standard Judging of Search” of Step S05, it is investigated whether the chromosome group of the generated next generation is meeting the standard for ending search. When the standard is met, search is ended and a chromosome with the highest fitness in the chromosome group in that time is considered as the solution which is asked for the optimization problem. When a terminating condition is not satisfied, it returns to processing of “Evaluation of Chromosome” and search is continued. The following is typical termination standard of search although it depends on the character of the optimization problem which should be solved.

(a) The maximum fitness in a chromosome group became larger than a certain threshold value.

(b) The whole chromosome group's average fitness became larger than a certain threshold value.

(c) The generation in which the rate of increase of the chromosome group's fitness is less than a certain threshold value is continued more than a fixed period.

(d) The number of the alternation of generations is reached the number of times appointed beforehand.

By the conventional method which utilized the above-mentioned genetic algorithm, OPC was performed to all figures of the mask which defines the circuit pattern of a semiconductor chip according to need. For this reason, according to the increase of the number of figures owing to microfabrication, processing time is huge. There is a case where the 90 nm node device has actually taken tens of hours. By the further microfabrication, OPC becomes a more complicated thing which has more numbers of figures because of the lowering of exposure contrast by forming a pattern in ultimate resolution for exposure. The time taken by a mask pattern generation has come to reach even several days in a 65 nm node device. On the other hand, the product cycle of the semiconductor device is short and shortening of OPC processing time has been a very big problem.

While increase of OPC processing time worsens manufacture TAT (Turn Around Time) of the semiconductor device comprising a mask pattern generation, it causes increase of cost.

Then, an object of the present invention is to provide the mask pattern design technology which includes OPC processing which realizes shortening of the increasing OPC processing time, shortens manufacture TAT of a semiconductor device, and reduces cost.

Another object of the present invention is to provide the manufacturing technology of an electronic circuit device and a semiconductor device which enables the mask pattern generation in practical time, and shortens the manufacture period.

The above-described and the other objects and novel features of the present invention will become apparent from the description herein and accompanying drawings.

Of the inventions disclosed in the present application, typical ones will next be summarized briefly.

To the cell library pattern which makes the basic constitution of a semiconductor circuit pattern, OPC processing (first proximity effect correction) is performed beforehand, and a semiconductor chip is produced using this cell library pattern to which OPC processing was done.

At this time, since the cell library pattern by which OPC processing was done beforehand is influenced by the pattern of the cell arranged to the circumference, and the pattern arranged around other cells, it performs correction processing (optimization processing; second proximity effect correction) with it.

The part of this correction processing is a portion in which a pattern faces between cell boundaries in the inside of the region specified from the cell boundary, and proximity effect correction is performed by making the width, the length, and the position of this portion into variables. Or proximity effect correction is performed by making a polygon into a variable. Or sizing (fixed-quantity adjustment) is done and proximity effect correction is performed.

As further method, genetic algorithm performs this correction processing in consideration of the degree of incidence by the pattern of the circumference extracted beforehand. Optimization techniques, such as genetic algorithm, are excellent as a method of optimizing a huge combination at high speed. The time of correction processing is accelerated by using these techniques, and it can do for a short time compared with conventional all of the pattern OPC processings. This is because it is suitable for parallel processing in addition to that driving-into manday is short.

Advantages achieved by some of the most typical aspects of the invention disclosed in the present application will be briefly described below.

(1) By performing OPC processing at first per cell and saving them, forming all figures of the mask from combination of these saved cells, and performing OPC regulated treatment between cells in all figures of the mask, processing time is substantially reducible.

(2) When OPC processing of a cell unit is beforehand held as a library and share usage is done between products, since OPC processing between cell units becomes main substantially as to the OPC processing time for every product, as compared with the case where it carries out to all figures of the mask, the number of combination (the number of parameters) decreases substantially, therefore the convergence time to these optimization also decreases substantially.

### BRIEF DESCRIPTIONS OF THE DRAWINGS

FIG. 1 is a flow chart showing the procedure of the genetic algorithm examined as a premise of the present invention;

FIG. 2 is a drawing showing an example of expression of a chromosome used for the OPC processing method examined as a premise of the present invention;

FIG. 3 is a drawing showing the mask pattern currently used for the gate of SRAM in Embodiment 1 of the present invention;

FIG. 4 is a drawing showing the mask pattern used for verification of the present invention in Embodiment 1 of the present invention;

FIG. 5 is a drawing showing the example of a transfer pattern and measurement part of a mask pattern of FIG. 4;

FIG. 6 is a drawing showing the example of an exposure pattern of P1 and P3 of the mask pattern of FIG. 4;

FIG. 7 is an enlarged view of P3 of the mask pattern of FIG. 4;

FIG. 8 is an enlarged view of P1 of the mask pattern of FIG. 4;

FIG. 9 is a drawing showing the setting part of the optimizing parameter in the exposure pattern of P1 and P3 of the mask pattern of FIG. 4;

FIG. 10A is a symbol picture showing the NAND gate in Embodiment 2 of the present invention;

FIG. 10B is a circuit diagram of FIG. 10A showing the NAND gate in Embodiment 2 of the present invention;

FIG. 10C is a plan view showing the pattern layout of FIG. 10A showing the NAND gate in Embodiment 2 of the present invention;

FIG. 11 is a drawing showing a unit logic cell, and the dashed line which defines a section in the NAND gate of FIGS. 10A to 10C;

FIGS. 12A to 12F are drawings showing the mask used when forming the unit cell part of the NAND gate of FIGS. 10A to 10C;

FIGS. 13A to 13E are the sectional views taken along the dashed line of FIG. 11, and are process charts which express till an element isolation step;

FIGS. 14A to 14E are the sectional views taken along the dashed line of FIG. 11, and are process charts which express till gate formation;

FIGS. 15A to 15E are the sectional views taken along the dashed line of FIG. 11, and are process charts which express till formation of a part of wirings;

FIG. 16 is a drawing showing the structure of the mask pattern of FIG. 12D;

FIG. 17 is a drawing showing the example which did gene expression of the difference size from the design objective in FIG. 16;

FIG. 18 is a drawing showing the example which performed grouping of the cell based on the relative position in Embodiment 2 of the present invention;

FIG. 19 is a drawing showing the measurement part of the size for acquiring the fitness of a chromosome in Embodiment 2 of the present invention;

FIG. 20 is a drawing showing the difference image of a designed pattern and a resist pattern in Embodiment 2 of the present invention;

FIG. 21 is a flow chart in which a semiconductor device manufacture process is shown in Embodiment 9 of the present invention;

FIG. 22 is a drawing showing the cell of the cell library to which OPC in the cell single body is given in Embodiment 3 of the present invention;

FIG. 23 is an enlarged view of the cell of FIG. 22;

FIG. 24 is a drawing showing an example of the adjustment variable of gate width w1 in Embodiment 3 of the present invention;

FIG. 25 is a drawing showing an example of the adjustment variable of doubling margins d1 and d2 between a contact and a diffusion layer in Embodiment 3 of the present invention;

FIG. 26 is a drawing showing an example of resolving failure (pattern relation failure) evasion between contiguity cells in Embodiment 3 of the present invention;

FIG. 27 is a drawing showing the example of the gate wiring riding failure evasion to a diffusion layer in Embodiment 3 of the present invention;

FIG. 28 is a drawing showing the re-OPC adjustment portion of gate length, resolving failure (pattern relation failure) evasion margin s4 between contiguity cells, gate wiring riding failure evasion margin s3 to a diffusion layer, and the amount p1 of ejection from an active region in Embodiment 3 of the present invention;

FIGS. 29A and 29B are the drawings showing an example of gate length's adjustment variable in Embodiment 3 of the present invention;

FIG. 30 is a drawing showing the example of resolving failure (pattern relation failure) evasion between contiguity cells in Embodiment 3 of the present invention;

FIG. 31 is a drawing showing the example of the gate wiring riding failure evasion to a diffusion layer in Embodiment 3 of the present invention;

FIGS. 32A to 32C are drawings showing an example of the ejection correction from an active region in Embodiment 3 of the present invention;

FIG. 33 is a drawing showing the sample layout of a contact layer in Embodiment 3 of the present invention;

FIG. 34 is a drawing showing an example of the adjustment variable of a contact pattern in Embodiment 3 of the present invention;

FIGS. 35 to 37 are top views showing the sample layout of a semiconductor circuit pattern in Embodiment 4 of the present invention;

FIG. 38 is a flow chart showing extraction and the procedure of adjustment of the variable of the proximity effect correction accompanying proximity between cells in Embodiment 4 of the present invention;

FIGS. 39A to 42B are the explanatory diagrams showing the variables sampling method of the proximity effect correction accompanying proximity between cells in Embodiment 5 of the present invention;

FIG. 43 is an explanatory diagram showing the variables sampling method of the proximity effect correction accompanying proximity between cells in Embodiment 6 of the present invention;

FIGS. 44A to 44D are explanatory diagrams showing the variable correction method of the proximity effect correction accompanying proximity between cells in Embodiment 6 of the present invention;

FIG. 45 is an explanatory diagram showing the variables sampling method of the proximity effect correction accompanying proximity between cells in Embodiment 7 of the present invention;

FIG. 46 is an explanatory diagram showing the concept of a cell group division in Embodiment 8 of the present invention;

FIG. 47 is an explanatory diagram showing the method for performing distinction of an adjustment object at high speed in Embodiment 8 of the present invention;

FIG. 48 is a drawing showing lithography conditions in Embodiment 1 of the present invention;

FIG. 49 is a drawing showing two evaluation values of the transfer pattern of FIG. 4; and

FIG. 50 is a drawing showing the result of optimization of the parameter shown in FIG. 9.

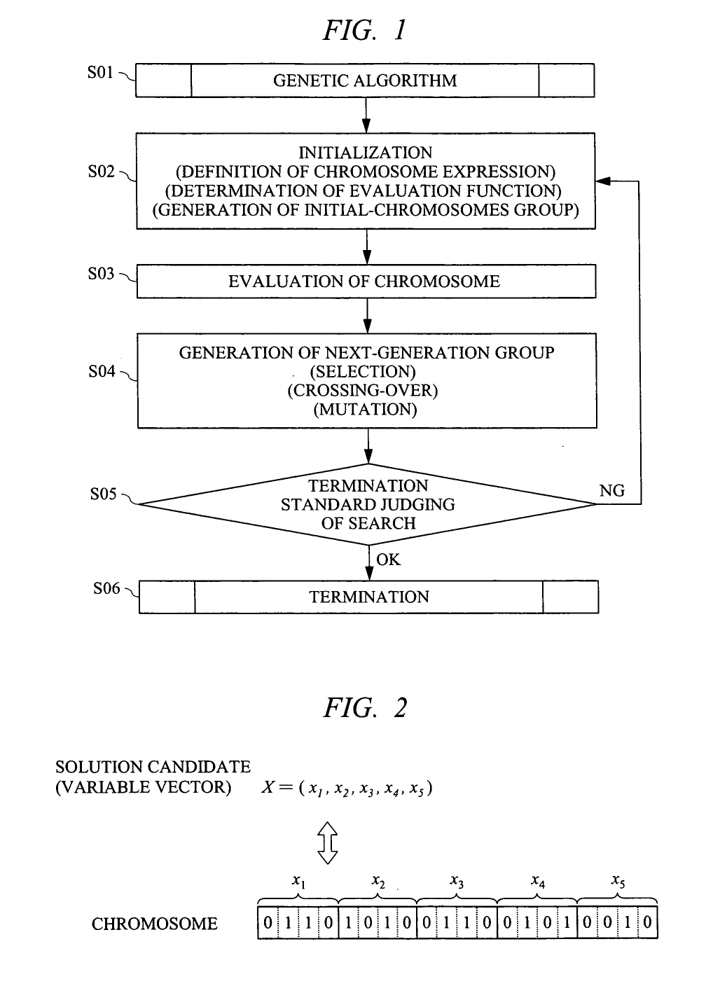

### DESCRIPTIONS OF THE PREFERRED EMBODIMENTS

Hereafter, embodiments of the invention are explained in detail based on drawings. In all the drawings for describing the embodiments, the same member will be identified by the same reference numerals in principle and overlapping descriptions will be omitted.

### Embodiment 1

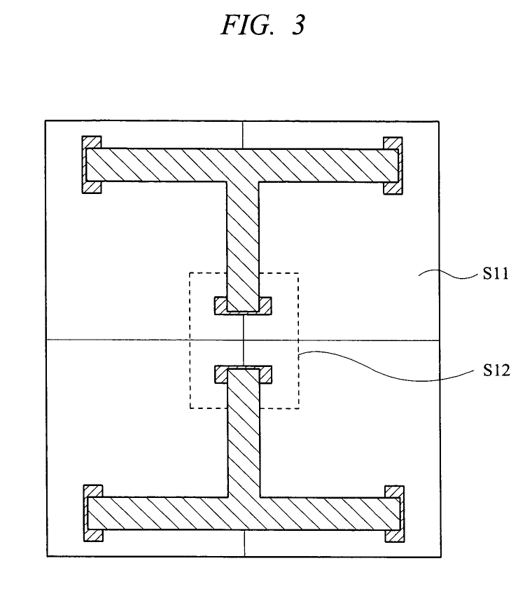

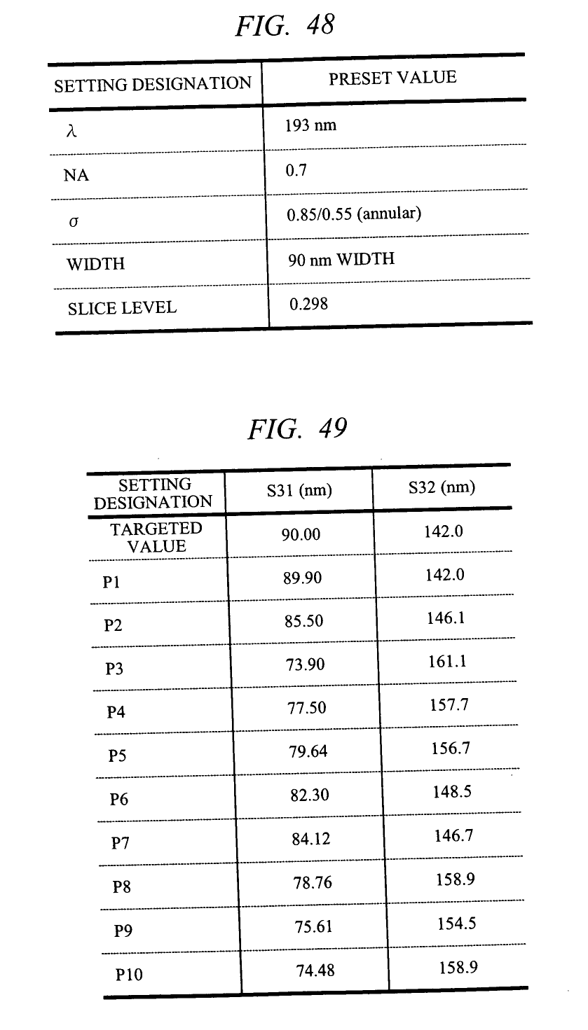

The mask pattern according to Embodiment 1 of the present invention is designed using a computer etc. In order to verify the validity of the present invention, one of the mask patterns currently used for the gate of SRAM shown in FIG. 3 was used as a cell and the present invention was applied to this. First, the verification experiment of whether to have influence on transfer of a mask pattern according to peripheral environment was conducted. Next, the pattern design technique using genetic algorithm which is the technique of the present invention was applied to the pattern with the strongest influence also in it, and the verification experiment of whether to be able to optimize was conducted. In the experiment described henceforth, verification was performed under lithography conditions as shown in FIG. 48.

The above-mentioned transfer pattern is generated by optical simulation software. “SOLID-C” (trademark) of Litho Tech Japan Corp. is known as a producer of this software, for example, and this software is common knowledge at a person skilled in the art (reference URL;http://www.ltj.co.jp/index.html).

[Verification Experiment 1]

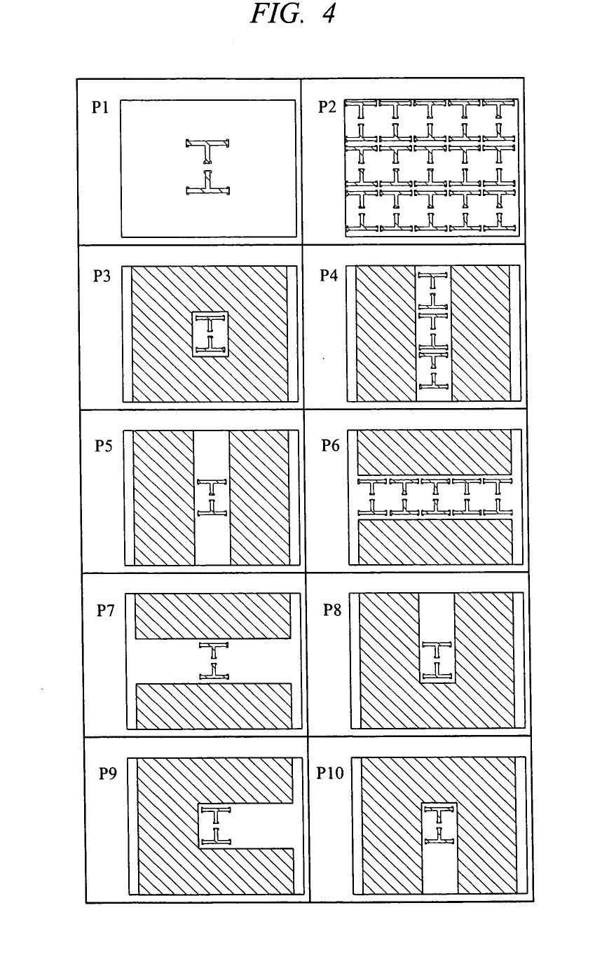

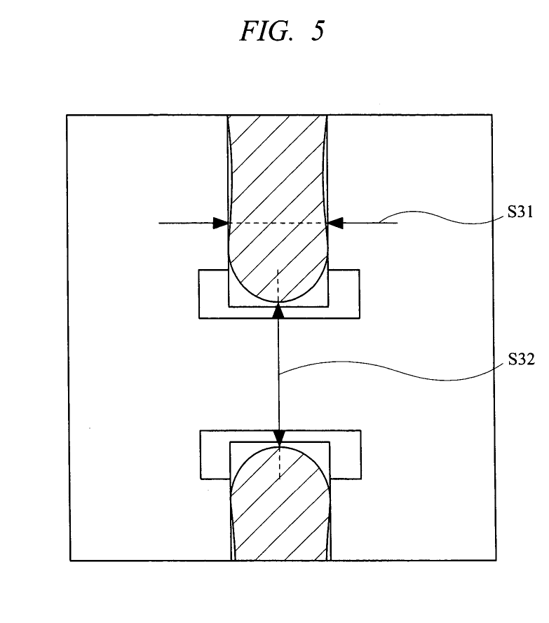

First, the verification experiment of whether a mask pattern is influential with the difference in peripheral environment was conducted. The pattern used for verification is shown in FIG. 4. Since these ten patterns are designed by a width of 90 nm, ideal line width is 90 nm. In this experiment, these transfer patterns are created and the influence of peripheral environment is verified by comparing two values, width A (S31), and the length of gap B (S32), shown in FIG. 5 (enlargement of S12 of FIG. 3) as an evaluation value.

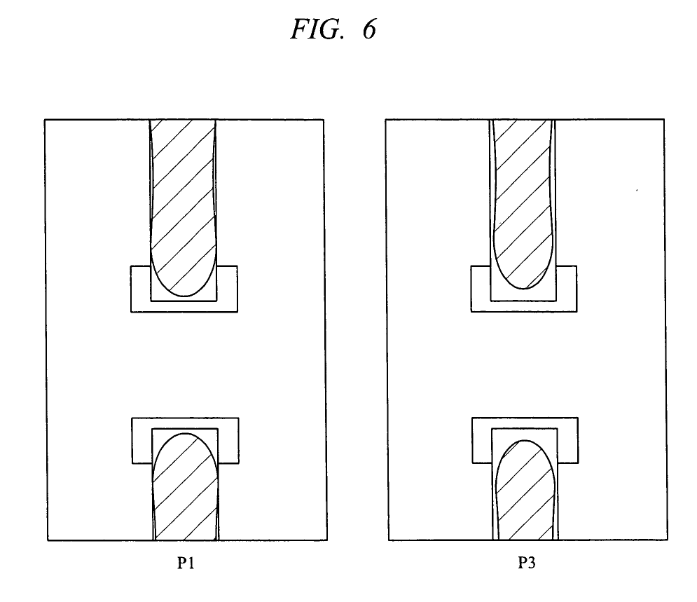

Two evaluation values of the transfer pattern of all the patterns of FIG. 4 are shown in FIG. 49. In P1, since there is no influence of peripheral environment, it has ideal line width, but P2, P3, etc. have the great influence from the circumference, and it turns out that line width S31 and gap S32 are greatly shifted as compared with P1. The transfer patterns of P3 with the greatest influence and ideal pattern P1 are shown in FIG. 6. Not only in line width S31 or gap S32, it turns out that great influence is received on the whole. When the evaluation value of other patterns is compared, it turns out that the affecting degree to a transfer pattern changes with differences in peripheral environment. In an actual mask pattern, since it combines and uses various cells, it can expect that the influence also becomes very greatly and complicated. Therefore, also in the mask pattern of the same design, the complicated optimization of an OPC mask adjusted with peripheral environment is indispensable.

[Verification Experiment 2]

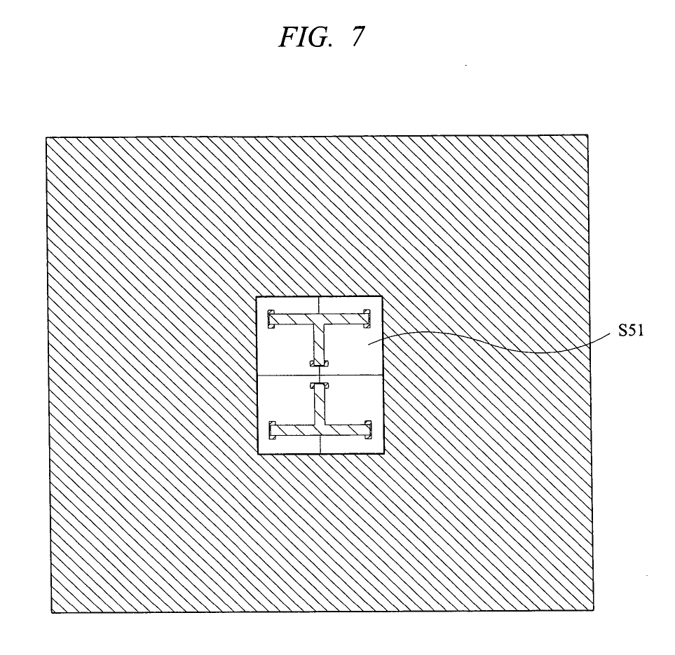

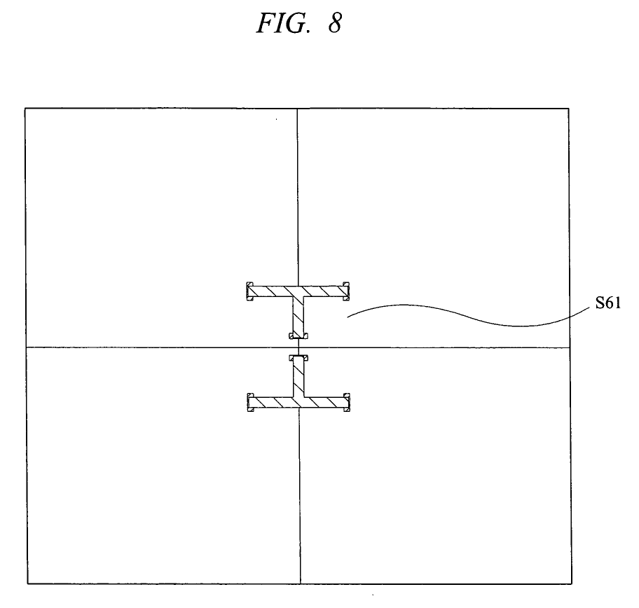

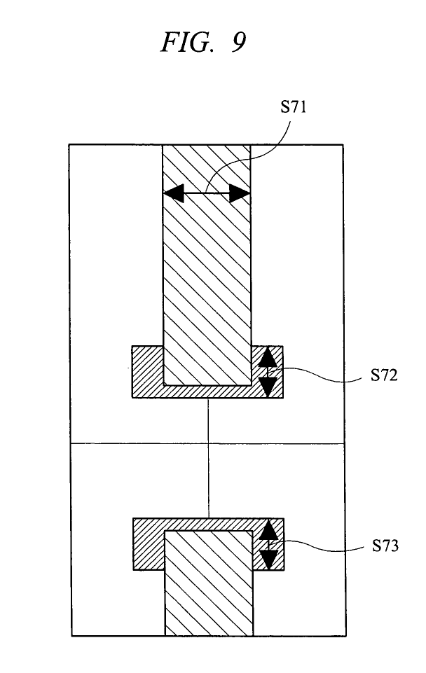

The verification experiment of whether the influence by peripheral environment proved in verification experiment 1 is solvable with the technique of the present invention was conducted. In this verification experiment 2, the simulation which optimizes P3 (FIG. 7) of the pattern which was the most influential in verification experiment 1 making the mask pattern of P1 (FIG. 8) nearest to an ideal a target was performed as easiest example. In this simulation, it optimized with the technique of the present invention by making into an optimizing parameter 2 places S71 and S72 in the cell shown in FIG. 9 (enlargement of the transfer pattern of S12 of FIG. 3).

Below, the application method of genetic algorithm is described. Since the calculation procedure of genetic algorithm is as having described in the above “Summary of the Invention”, here is explained the detail of each step.

“Initialization: Definition of Chromosome Expression”

In this simulation, since S71 and S72 which are shown in FIG. 9 are made into an optimizing parameter, it considers that variable vector X is a two-dimensional vector like X=(x₁, x₂), and the real number expresses each element xᵢ (i=1, 2). Here, S73 shall take a value always equal to S72.

“Initialization: Determination of Evaluation Function”

Since an explicit function cannot define fitness, the procedure of the fitness calculation which includes the four following steps is adopted.

Step (1): Reconstruct a figure pattern using the variable vector which becomes settled uniquely from a chromosome.

Step (2): Perform an optical simulation and calculate an exposure pattern.

Step (3): About the calculated exposure pattern, measure the size in S31 and S32 in FIG. 5, and calculate the sum of error with a designed value.

Step (4): Since a target here is obtaining the exposure pattern which is infinitely close to a designed value, the smaller the error is, the better it is. Then, the reciprocal of the sum of the measured error is made into fitness.

“Generation of Initialization: Initial-Chromosomes Group”

Let the vector which includes two real value elements here be a chromosome according to the rule decided in the above “Initialization: Definition of Chromosome Expression”. Number N of chromosome is set to 100 and 100 chromosomes are generated at random using a pseudorandom-numbers generator.

“Evaluation of Chromosome”

All the chromosomes are evaluated according to the evaluation procedure of a chromosome determined in the above “Initialization: Determination of Evaluation Function”, and fitness is calculated.

“Generation of Next-Generation Group: Selection”

Roulette choice is used in Embodiment 1. This is a system in which the probability that each chromosome can survive in the next generation is proportioned to fitness. That is, when fitness is high, the arrangement on roulette will increase so much, and the probability when turning roulette of hitting becomes large. Concretely, when a chromosome group's size is set to N, fitness of the i-th chromosome is set to Fᵢ and total of the fitness of all the chromosomes is set to Σ, it realizes by repeating the procedure which extracts each chromosome with the probability of (Fᵢ/Σ) N times. Since number of chromosome is 100 in the above-mentioned case, 100 next-generation chromosomes will be chosen by repeating the procedure 100 times.

“Generation of Next-generation group: Crossing-over”

Uniform crossing-over is used in Embodiment 1. This is the method in which two chromosomes are selected out of each chromosome group, and whether exchange the variable which is a gene is determined at random in each genetic locus. Two selected chromosomes are concretely made into X¹=(x¹₁, x¹₂) and X²=(x²₁, x²₂), respectively, and random number generation which outputs 0 or 1 with one half of probability is performed twice. The first random number is against the first genetic locus, when becoming 1, it will exchange x¹₁ and x²₁, and when becoming 0, it will not exchange them. The processing to the second genetic locus is also the same.

“Generation of Next-Generation Group: Mutation”

In Embodiment 1, the processing which adds the random number generated according to the normal distribution is adopted to the genetic locus selected by mutation rate PM according to uniform distribution. Here, it was set as mutation rate P_{M}=1/50, average u=0 of a normal distribution, and standard deviation σ=5×10ˆ9.

“Terminating Condition of Search”

In Embodiment 1, when the chromosome whose error with a designed value is 0 was discovered, or when evaluation of chromosomes was performed 5000 times, search is terminated.

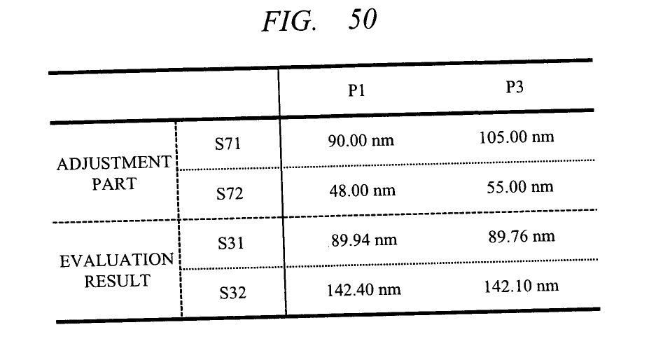

As a result of conducting a verification experiment using the above genetic algorithm, a result like FIG. 50 was obtained by optimizing the parameter shown in FIG. 9. Therefore, it turns out that what was narrow by about 16nm as to width S31 of the transfer pattern by the peripheral environment of FIG. 7 as shown in FIG. 49 of verification experiment 1 was optimized with the technique of the present invention to about 90 nm which is near to ideal value of FIG. 8.

By this experiment, it was confirmed that the technique of the present invention can optimize the drift of the transfer pattern under the influence from peripheral environment in a mask pattern design.

In Embodiment 1, there was explained the case where the simple sum of the error of S31 and S32 was used. Although the simple sum is general-purpose, the method of attaching weight according to the weight of a place and taking the sum is also useful. For example, when size control of line width S31 used as a gate is important, by multiplying the value of S32 by the coefficient of 2 or 3, the accuracy of a required place will go up relatively.

### Embodiment 2

Another example in which semiconductor integrated circuit devices were manufactured using the mask designed by the mask pattern design method according to the present invention is explained.

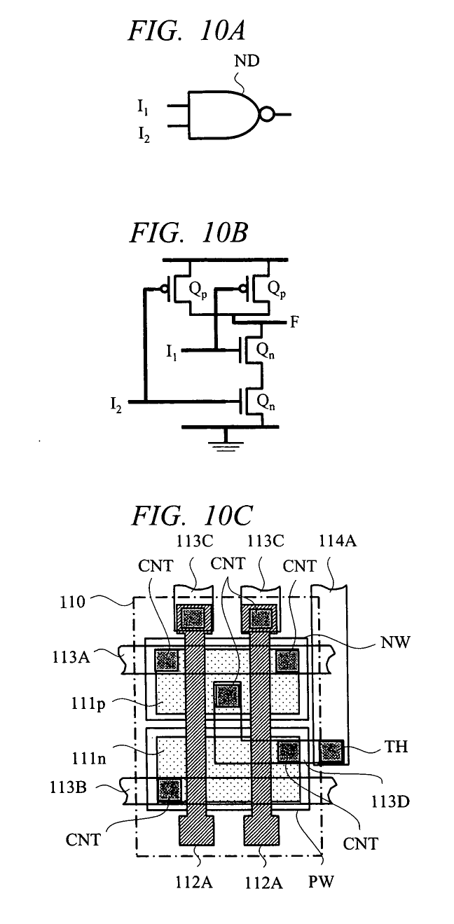

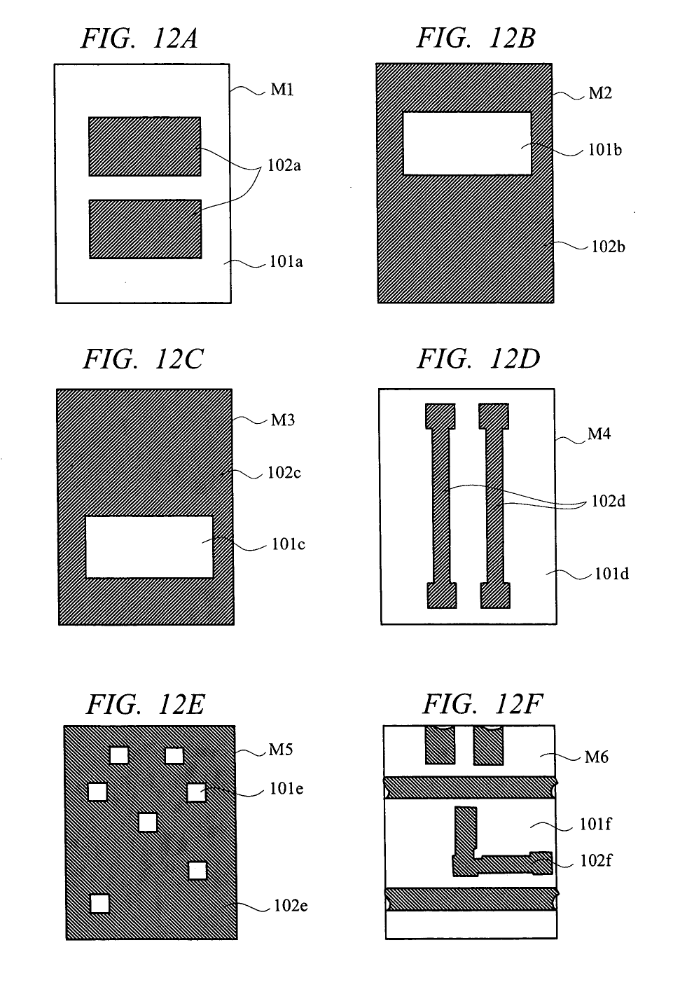

FIGS. 10A to 10C express NAND gate circuit ND of 2 inputs, FIG. 10A shows a symbol picture, FIG. 10B shows the circuit diagram, and FIG. 10C shows a layout plan view. The portion surrounded by chain-dotted line in FIG. 10(c) is unit cell 110, and includes two nMOS portions Qn formed on n-type semiconductor region 111n of the front surface of p type well region PW and two PMOS portions Qp formed on p-type semiconductor region 111p of the front surface of n type well region NW. In order to produce this structure, the pattern transfer by the usual optical lithography was repeated, using masks M1-M6 as shown in FIGS. 12A to 12F one by one. Among them, since masks M1-M3 have a pattern of comparatively big size, OPC processing of the pattern was not performed. Among FIGS. 12A to 12F, 101a, 101b, and 101c are light transmission sections, and 102a, 102b, and 102c are the shade parts by a chromium film.

On the other hand, since masks M4-M6 have a fine pattern, they were optimized by changing the outline and size of a pattern figure suitably using the mask pattern design method according to the present invention. Among FIGS. 12A to 12F, 101d, 101e, and 101f are light transmission sections, and 102d, 102e, and 102f are shade parts.

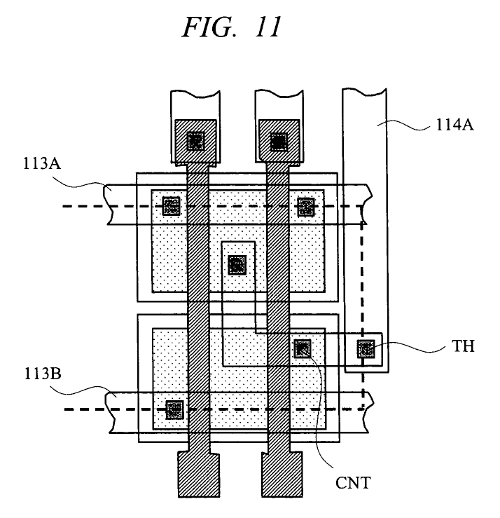

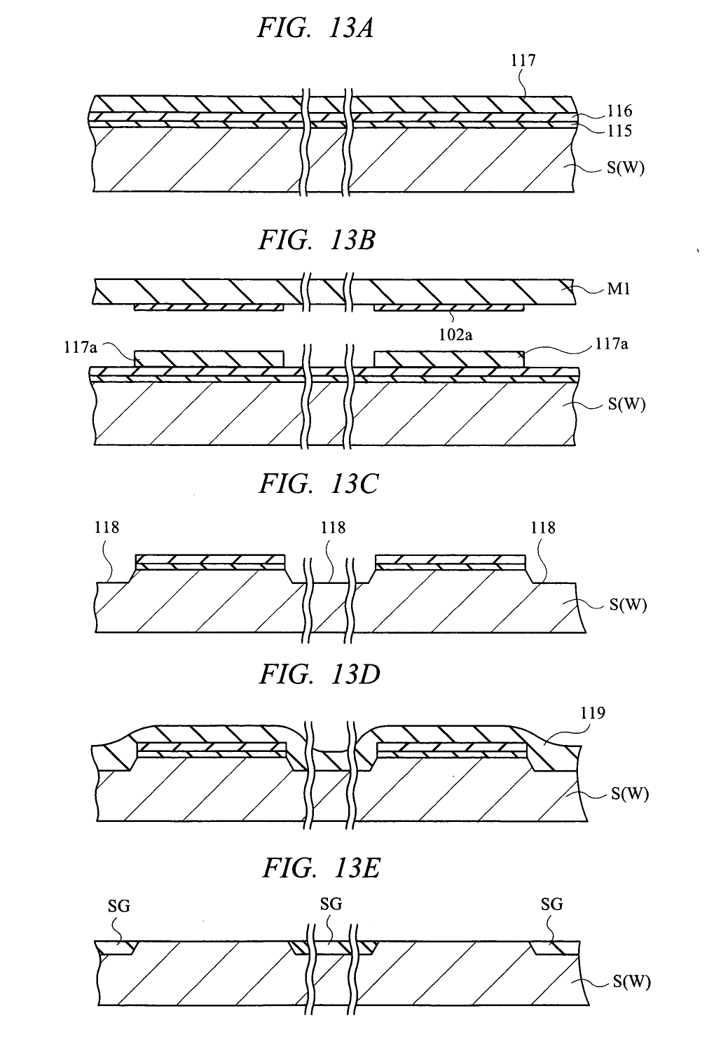

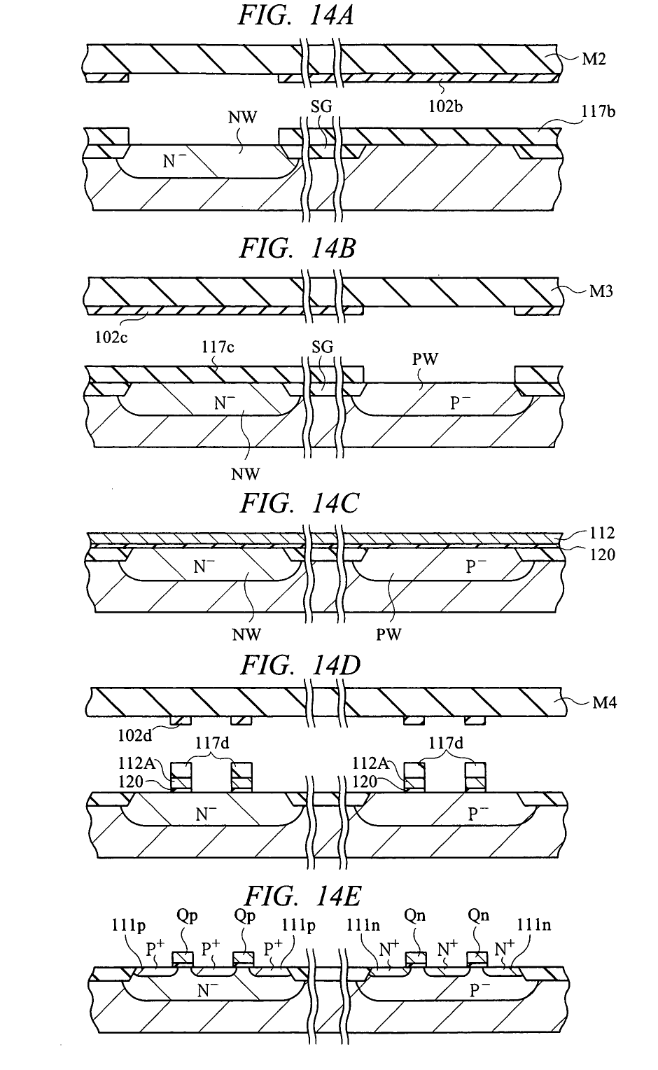

In the FIG. 11 showing the same layout as FIG. 10C, steps until they form channels Qp and Qn are shown in FIGS. 13A to 14E using the cross-sectional views supposing the cross-section taken along the broken line. After forming insulating film 115 made of a silicon oxide film, for example with an oxidation method on wafer S (W) made of a silicon crystal of a P-type, silicon nitride film 116 is deposited by the CVD (Chemical Vapor Deposition) method on it, and resist layer 117 is further formed on it (FIG. 13A). Next, exposure development processing is performed using mask M1, and resist pattern 117a is formed (FIG. 13B). Then, insulating film 115 and silicon nitride film 116 which are the layers exposed from there are removed in order by using resist pattern 117a as an etching mask, resist is removed further, and trench 118 is formed in a surface of the wafer S (W) (FIG. 13C). Next, after depositing insulating film 119 made of, for example silicon oxide with a CVD method etc. (FIG. 13D), by performing flattening processing, for example with the Chemical Mechanical Polishing method (CMP: Chemical Mechanical Polishing) etc., element isolation structure SG is formed eventually (FIG. 13E). In Embodiment 2, although SG was made into trench type isolation structure, without being limited to this, it may be formed, for example from a field insulating film by the LOCOS (Local Oxidization of Silicon) method.

Then, exposure development is performed using mask M2, and resist pattern 117b is formed. Since the region in which n type well region should be formed is exposed, ion implantation of phosphorus or arsenic is done, and n type well region NW is formed (FIG. 14A). After forming resist pattern 117c with mask M3 similarly, the ion implantation of the boron etc. was done and p type well region PW was formed (FIG. 14B). Next, gate insulating film 120 of a silicon oxide film is formed in 3 nm in thickness by a thermal oxidation method, and polycrystalline silicon layer 112 is further deposited with a CVD method etc. on it (FIG. 14C).

Then, resist pattern 117d was formed using mask M4 after the resist application, and gate insulating film 120 and gate electrode 112A were formed by etching of polycrystalline silicon layer 112, and removal of resist (FIG. 14D). Then, n-type semiconductor regions 111n of high impurity concentration for n channel MOS's and p-type semiconductor regions 111p of high impurity concentration for p channel MOS's which function also as source and drain regions and a wiring layer were formed in self align to gate electrode 112A with ion implantation or a diffusion method (FIG. 14E).

NAND gate group of 2 inputs was manufactured by choosing a wiring suitably at future steps. Here, when changing the form of a wiring, it is needless to say that other circuit, such as a NOR gate circuit, can be formed, for example. Here, the example of manufacture of the NAND gate of 2 inputs is succeedingly described using masks M5 and M6 shown in FIGS. 12E and 12F.

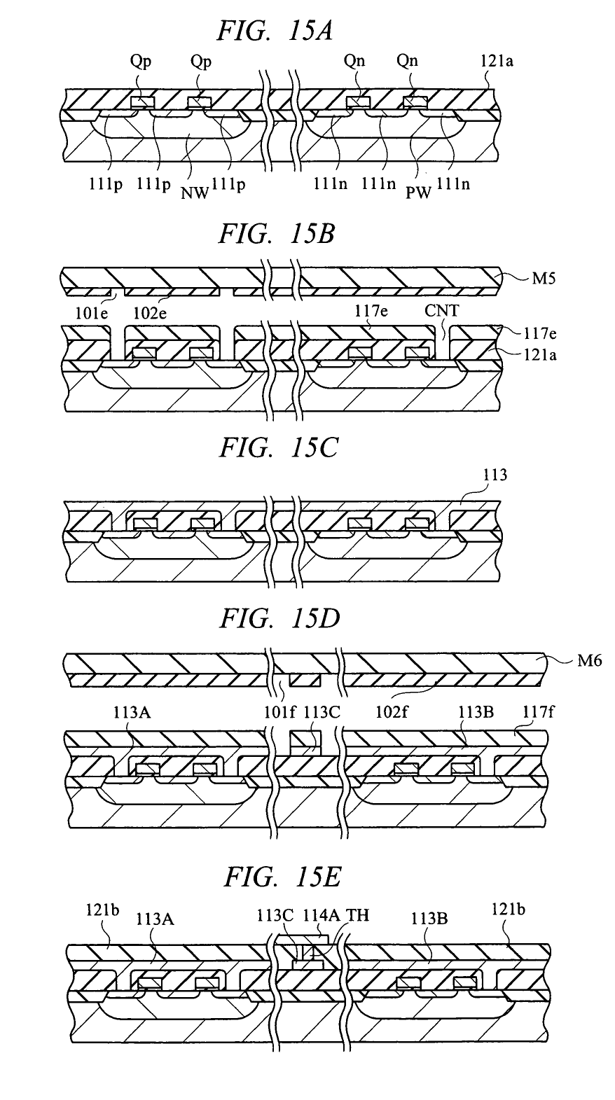

FIG. 15 is the cross-sectional view taken along the broken line shown in FIG. 11, and shows the wiring formation step. On two n channel MOS parts Qn and two p channel MOS parts Qp, an interlayer insulation film, for example interlayer insulation film 121a made of a silicon oxide film in which phosphorus was doped is deposited with a CVD method (FIG. 15A). Then, after applying resist and forming resist pattern 117e using mask M5, contact hole CNT is formed by etching process (FIG. 15B). After removal of resist, metal, such as tungsten and a tungsten alloy or copper, is filled, and simultaneously metal layer 113 of these metals is formed further (FIG. 15C). Then, after applying resist and forming resist pattern 117f using mask M6, wirings 113A-113C were formed by etching process (FIG. 15D). Henceforth, interlayer insulation film 121b was formed and through hole TH, and the upper wiring 114A were formed using further other masks (not shown) (FIG. 15E). Connections between parts were performed by the pattern formation in which the similar step was repeated by the required number of times as well, and the semiconductor integrated circuit device was manufactured.

As mentioned above, a semiconductor integrated circuit device can be manufactured now by applying the method of the present invention using the reliable mask which guarantees pattern accuracy.

Among the above-mentioned masks which form a cell library, shielding patterns 102d especially in mask M4 form a gate pattern with the shortest size, and its required precision of the size of a transfer pattern is also the severest. Then, when having arranged the cell library pattern shown in mask M4 (FIG. 12D) all over a mask, the method of the present invention was adopted.

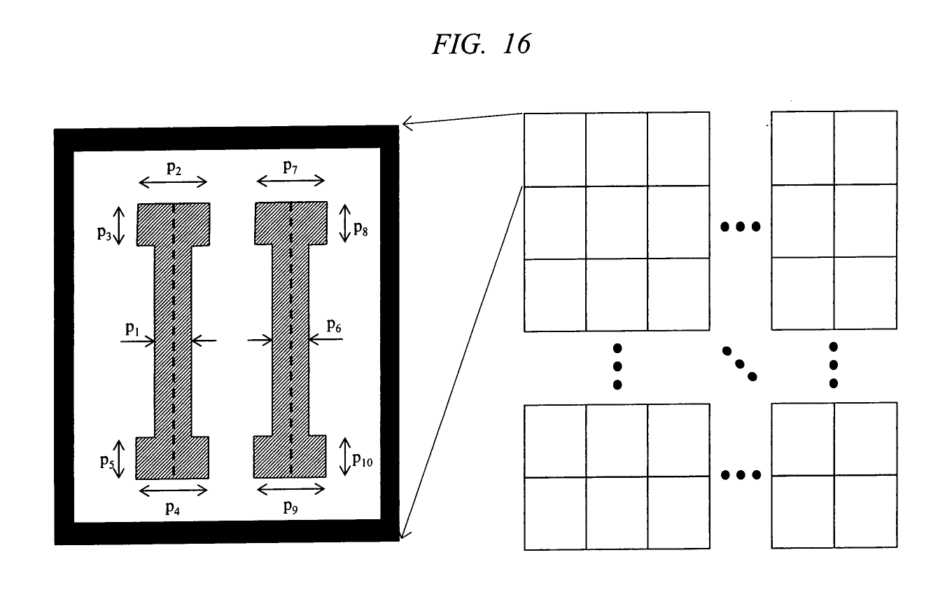

The whole mask pattern is comprised of a plurality of cells, and two I type figures are located in a line with each cell (FIG. 16). Each cell has ten adjustment portions from p₁ to p₁₀, as shown in the same drawing. Therefore, when the number of cells is made into N_{cell} individuals, the whole mask pattern needs to adjust the parameter of (N_{cell}×10) individuals.

“Initialization: Definition of Chromosome Expression”

In Embodiment 2, each variable is treated as the real number which shows the size of a figure directly. That is, each element xᵢ (i=1, 2, . . . , 10) of variable vector X shall be expressed with the real number, and each shall correspond to pᵢ (i=1, 2, . . . , 10) in FIG. 16.

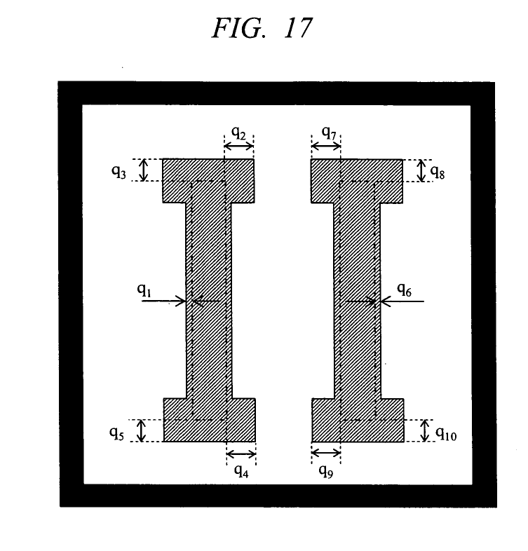

At this time, it is also possible to do gene expression of not the value of the size itself but the difference from a design objective. For example, in the case of FIG. 17, a shading figure is the mask pattern with which OPC was given, and the upside bar and bottom bar of one “I” type figure are added to up-and-down symmetry and a bilateral symmetry to the design objective shown with a chain-dotted line. Furthermore, a vertical line can also change their thickness symmetrically and a mask pattern is uniquely determined by specifying each size qᵢ (i=1, 2, . . . , 10). That is, the optimal mask pattern is obtained by genetic algorithm by considering that variable vector X=(q₁, q₂, . . . , q₁₀) is a chromosome.

Since the mask pattern where Ncell pieces of a cell of the same kind are located in a line is dealt with in Embodiment 2, the length of a chromosome also becomes N_{cell} times and becomes X=(X¹ X² . . . X^{Ncell})=(x¹₁, . . . , x¹₁₀, . . . , x^{Ncell}₁, . . . , x^{Ncell}₁₀). Here, X^{j} shall show the variable vector which includes ten elements for specifying the graphic shape included in the j-th cell, and x^{j}ᵢ shall show the i-th element of the variable vector corresponding to the j-th cell.

The real value may not express each element xᵢ of variable vector X, but n-ary number expression using a notation system of base n may be done by deciding a upper limit, a lower limit, and the number of quantization steps.

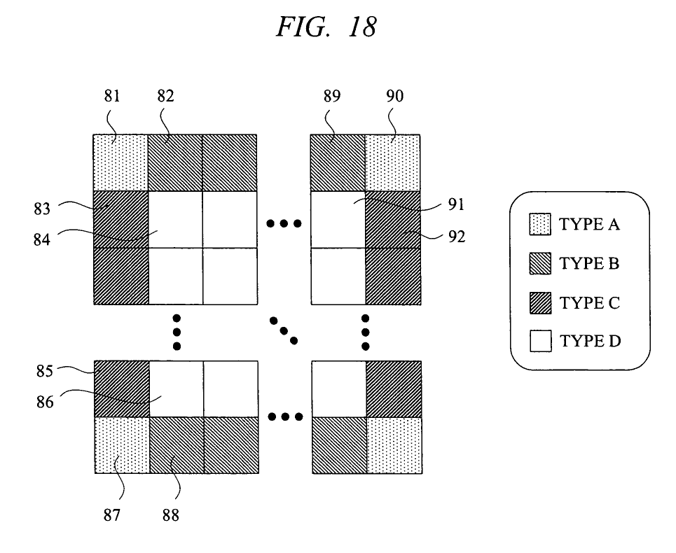

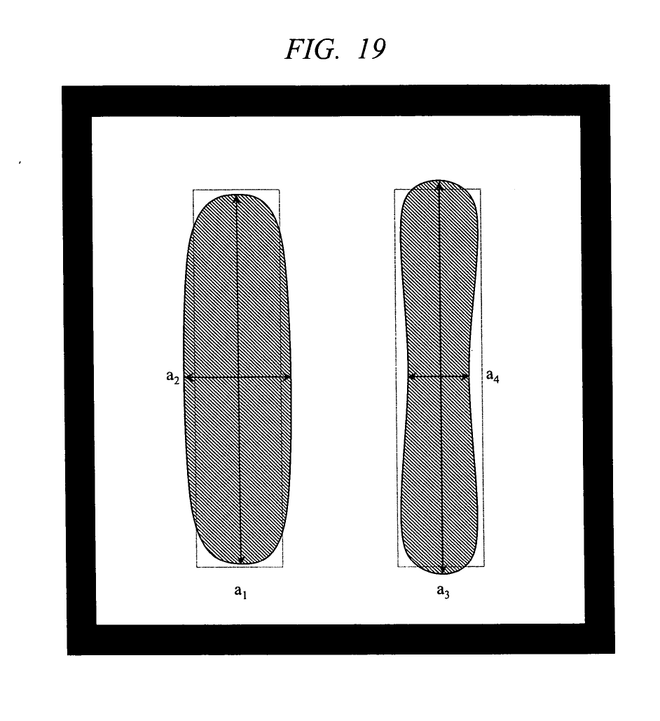

When the same cell is used like a memory etc., being arranged repeatedly regularly, search of the optimum value is not performed making all the variable vectors of all the cells an object, but optimization can be made easy, reducing the length of a chromosome by grouping. For example, when it is assumed in FIG. 18 that all the cells include a figure pattern of the same kind, and the figure is bilateral symmetry and up-and-down symmetry, all of the variable vector of all the cells are not made applicable to optimization. By classifying into four kinds from Type A to D, optimizing only the variable vector (X¹ X² . . . X⁴) which defines the figures of four cells, and applying the result to all the cells according to a type, the effect same with having adjusted the whole mask can be acquired. For example, in FIG. 18, five cells of an upside and left-hand side do not exist among circumference eight cells, but, as for cell 81, three cells, 82, 83, and 84, of right-hand side and the bottom exist. As for cell 90 bilaterally symmetrically, and as for cell 87 up-and-down symmetrically, the relation with surrounding cells (89, 92, 91, and 88, 85, 86) are the same as that of cell 81. Therefore, the result of optimization of cell 81 can be used also for cell 90 or cell 87. Thus, the adjustment process of optimization can be skipped.

“Initialization: Determination of Evaluation Function”

As a method for acquiring the fitness of a chromosome, the same procedure as Embodiment 1 is adopted here. However, measurement of the size in a step (3) was performed at four places shown in FIG. 19. In manufacture of the usual semiconductor chip, the portion which is not allowed few errors, either and the portion at which accuracy is not required are intermingled regarding the dimensional accuracy demanded. Then, it becomes easy to perform the optimization reflecting an intention of a mask designing person by doing selectively size measurement of the portion at which high accuracy is required, and performing fitness calculation. Similarly, in a mask designing stage, when it is possible to pinpoint the part at which a light proximity effect tends to generate and fitness is computed, it becomes easy for optimization to be performed preferentially from the difficult part of adjustment by giving weighting greatly to the portion.

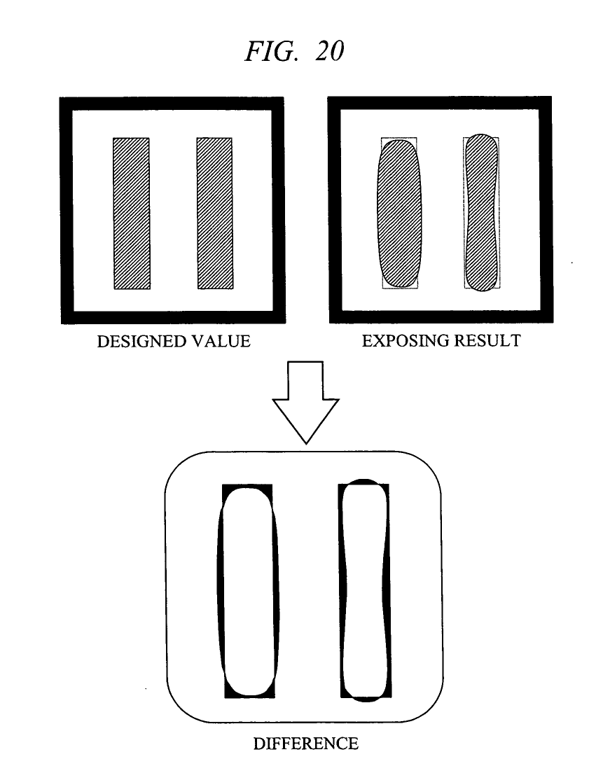

In Embodiment 2, in order to compare with a designed value the resist pattern predicted by the simulation, the size of several places was measured in the step (3) of fitness calculation. However, it becomes possible by using the area of the difference figure of a resist pattern and a designed pattern like FIG. 20 to detect without leakage the unexpected abnormalities in the part at which size measurement is not done. In this case, parameter optimization by genetic algorithm will be performed by making the reciprocal of the area of a difference figure etc. into an evaluation value.

In the step (4) of fitness calculation, although the reciprocal of the sum with error was adopted as fitness, it may also consider the subtraction value from the constant decided beforehand as fitness.

In the step (2) of fitness calculation, since a resist pattern can be predicted more accurately by carrying out the simulation of acid diffusion together, the accuracy of optimization can be improved.

“Generation of Initialization: Initial-Chromosomes Group”

An initial-chromosomes group is generated at random like the Embodiment 1. In order to improve search speed, it may start from the initial group which applied minute perturbation to the result corrected with model base OPC.

“Evaluation of Chromosome”

Like the Embodiment 1, according to the evaluation procedure of a chromosome decided in the above “Initialization: Determination of Evaluation Function”, all the chromosomes are evaluated and fitness is calculated.

“Generation of Next-Generation Group: Selection”

A roulette choice method is used like the Embodiment 1. Crossing-over systems, such as a tournament choice method and a rank choice method, and alternation-of-generations models, such as a MGG (Minimal Generation Gap) system, may be used (References: Sato et al., “the proposal and evaluation of an alternation-of-generations model in genetic algorithm”, Japanese Society for Artificial Intelligence, Vol. 12, No. 5, 1997).

“Next-Generation Group's Formation: Crossing-Over”

Uniform crossing-over is used like the Embodiment 1. In addition, the value acquired by doing a weighted mean rather than exchanging the genetic locus chosen at random may be used.

UNDX (Unimodal Normal Distribution Crossover) and Simplex Crossing-over which are the crossing-over systems developed for the chromosome in which real value expression was done in order to improve search speed and accuracy, EDX (Extrapolation-directed Crossover) etc. may be used (References: Sakuma et al., “Optimization of the nonlinear function by real value GA: the problem in the formation of high dimension of search space, and its solution”, the 15th Japanese Society for Artificial Intelligence National Conference, the 2nd A.I. Meeting of Youngman, MYCOM2001, 2001).

When expressing a chromosome by a binary vector, multipoint crossing-over can also be used except for uniform crossing-over.

“Generation of Next-Generation Group: Mutation”

The mutation using the random number generated according to a normal distribution is used like the Embodiment 1. In order to improve search speed and accuracy, the improvement speed of the fitness of the whole group may be supervised and the Adaptive Mutation method for increasing a mutation rate temporarily, when it does not improve beyond fixed time may be used together.

“Terminating Condition of Search”

Like Embodiment 1, when an error with a designed value becomes 0 or less than or equal to a constant value, or when the number of times of evaluation of a chromosome becomes beyond constant value, search is terminated.

Although the above is explanation of the genetic algorithm used by Embodiment 2, search speed and accuracy can be improved by using together other search techniques, such as the climbing-a-mountain method, the simplex method, a steepest descent method, the annealing method, and a dynamic programming method. By using other blind search technique or probabilistic search techniques, such as evolution strategy (Evolution Strategy; ES) or genetic programming (Genetic Programming; GP) besides genetic algorithm, properly, the much more improvement in search speed and the improvement in accuracy are realizable.

As described above, since a semiconductor chip is manufactured by using the cell library which performed OPC processing beforehand, and optimizing the influence of a surrounding cell library using the genetic algorithm by which high speed processing is possible, shortening of processing time of less than one tenths is attained compared with the conventional method of performing OPC processing to all the patterns.

### Embodiment 3

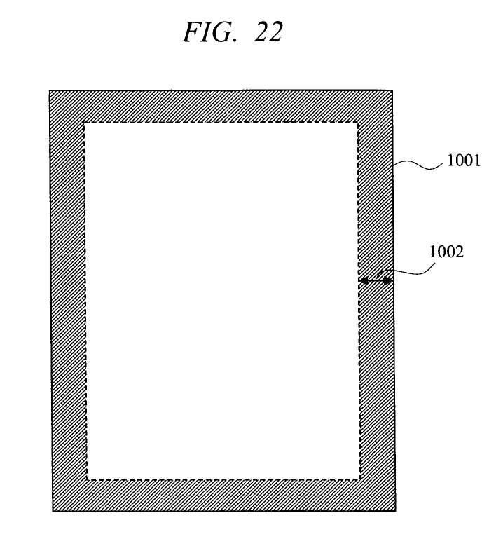

Another example of the variable which should be adjusted of the present invention is shown. 1001 of FIG. 22 is a cell of the target cell library, and, as for the pattern formed into this, OPC in the cell single body is given. The region where the pattern which receives correction of OPC under the influence of the circumference in this is included is a peripheral region in which hatching was done. Width 1002 of the region is about 2λ/NA although it is dependent on exposure wavelength λ of an aligner, numerical aperture NA of the used lens and the acid diffusion constant, standard dimensional accuracy, etc. of the used resist.

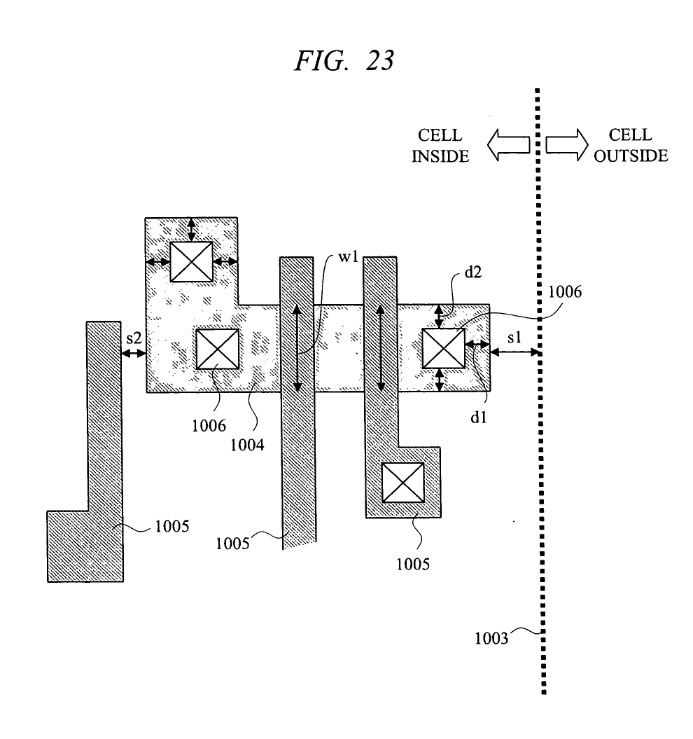

The example of a pattern layout in this peripheral region is shown in FIG. 23. In the drawing, 1003 is a cell part boundary region, 1004 is an active region (diffusion layer region), 1005 is a gate and a gate wire, and 1006 is a conduction hole (usually called “contact”). The outside of active region 1004 is an insulating region with a semiconductor substrate called the field, and is a region called isolation. The portion for which OPC re-correction is needed owing to the relation of arrangement between cells is divided and explained separately to an active layer (isolation layer), a gate layer, and a contact layer.

[Isolation Layer]

Gate width w1, doubling margins d1 and d2 between a contact and a diffusion layer, resolving failure (the pattern relation failure) evasion margin s1 with a contiguity cell, and gate wire riding failure evasion margin s2 to a diffusion layer which is shown in FIG. 23 are re-OPC adjustment portions. When gate width w1 is not settled in the accuracy of a standard, degradation of the transistor characteristics by a narrow channel effect happens, and when it becomes impossible to take the doubling margins d1 and d2 between a contact and a diffusion layer, the conduction failure by the increase in contact resistance happens.

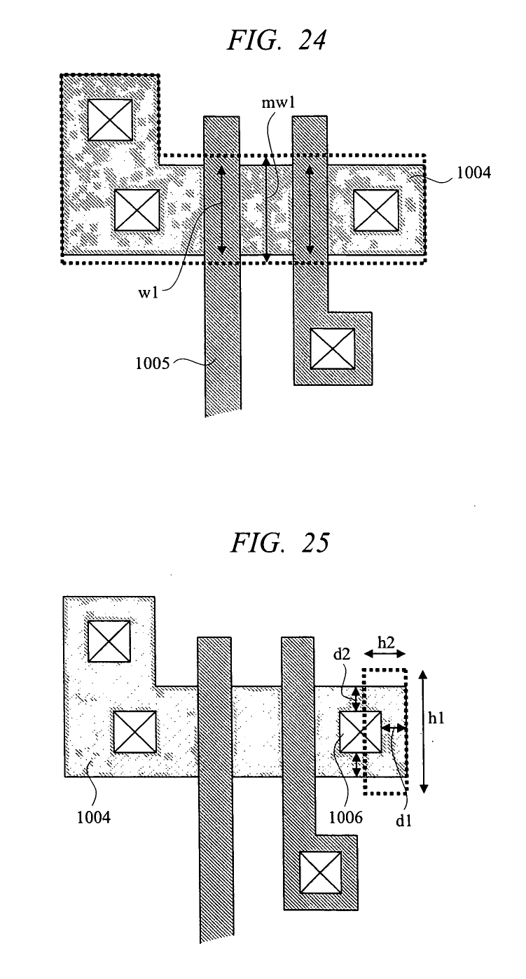

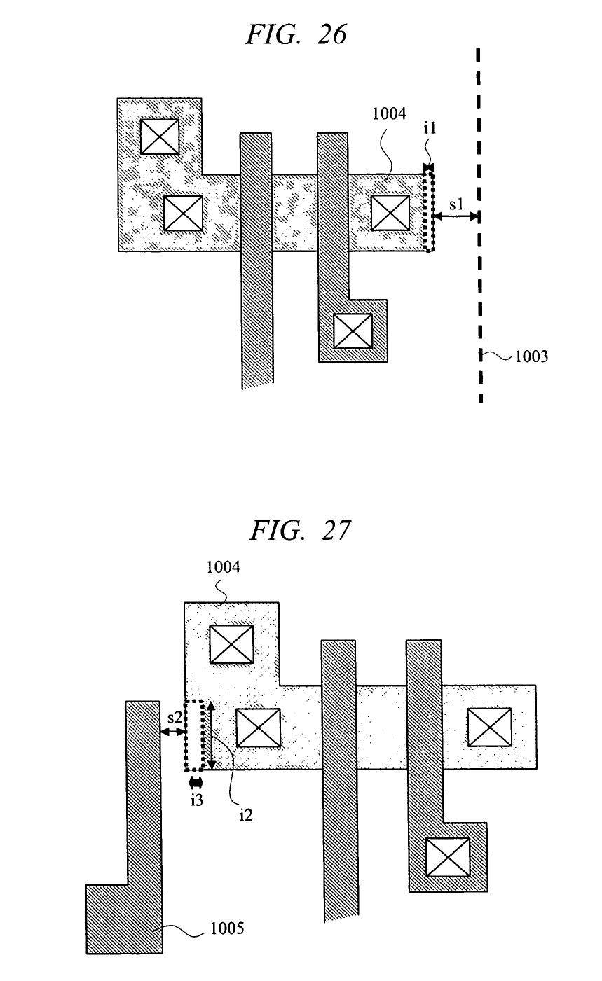

An example of the variable which should be adjusted of an active region is explained with reference to FIG. 24-FIG. 27. FIG. 24 is an example of the adjustment variable of gate width w1, and width mw1 is adjusted using the above-mentioned genetic algorithm technique. FIG. 25 is an example of the adjustment variable of the doubling margins d1 and d2 between a contact and a diffusion layer, and the end of the diffusion layer deformed in the shape of a hammer head of width h1 and length h2 is adjusted using the above-mentioned genetic algorithm technique. FIG. 26 is an example of resolving failure (pattern relation failure) evasion with a contiguity cell, and the amount of withdrawals at the tip of active region 1004 is made variable i1. FIG. 27 is an example of the gate wire riding failure evasion to a diffusion layer, and length i3 and width i2 of the withdrawal region of a portion opposite to gate wire 1005 are variables. These variables are adjusted using the above-mentioned genetic algorithm technique.

[Gate Layer]

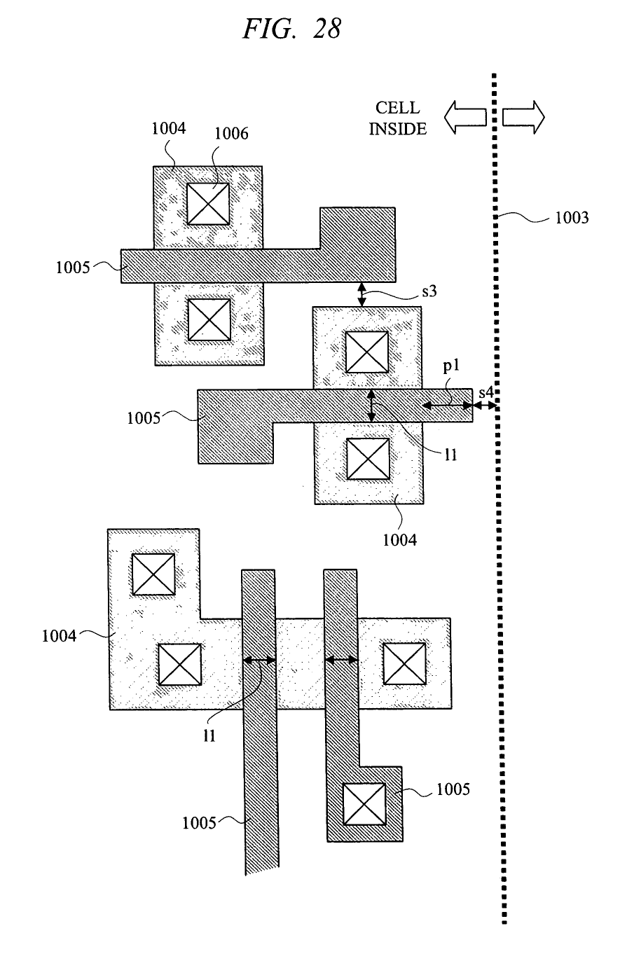

Gate length l1, resolving failure (pattern relation failure) evasion margin s4 with a contiguity cell, gate wire riding failure evasion margin s3 to a diffusion layer, and the amount p1 of ejection from an active region which is shown in FIG. 28 are re-OPC adjustment portions. When gate length l1 is not settled in the accuracy of a standard, transistor characteristics greatly vary since threshold potential control of a transistor stops becoming satisfactory, and circuit operation becomes unstable.

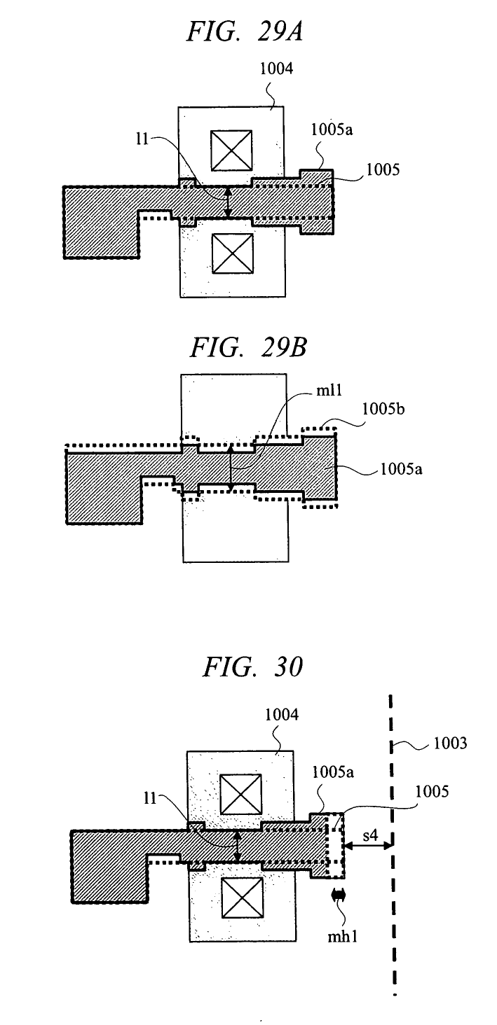

An example of the variable of a gate and a gate wire pattern which should be adjusted is explained with reference to FIG. 29A-FIG. 32C.

FIGS. 29A and 29B are examples of gate length's l1 adjustment variable. Since gate length is a size which affects transistor characteristics most sensitively, especially high dimensional accuracy is required. Usually, since the pad for taking conduction with a wiring layer is formed in a part of gate wires, a transfer pattern deforms in response to the influence of the diffracted light from the portion. In order to prevent the deformation on an active region at least, complicated OPC as shown in 1005a of FIG. 29A is applied. Here, OPC is applied so that desired dimensional accuracy may be acquired first of all in a cell independent case. Then, maintaining the contour of OPC with reference to another cell pattern arranged at the periphery, as shown in FIG. 29B, line width ml1 was made into the variable and adjusted using the above-mentioned genetic algorithm technique.

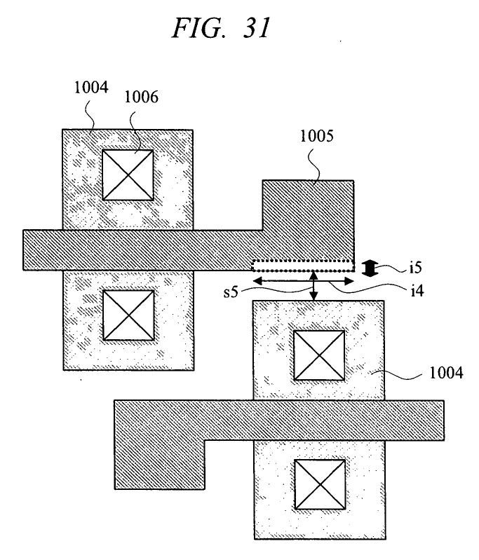

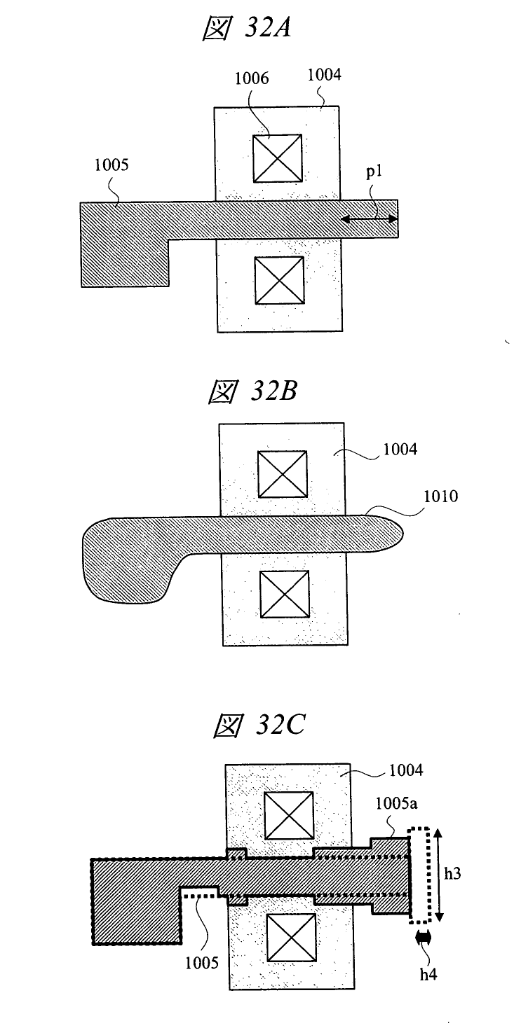

FIG. 30 is an example of resolving failure (pattern relation failure) evasion with a contiguity cell. Let amount mh1 of tip withdrawals of gate wire pattern 1005a which underwent OPC in the case of a cell independent be a variable. FIG. 31 is an example of the gate wire riding failure evasion to a diffusion layer, and the variables in this case are width i4 and depth i5 of a withdrawal portion of a gate wire opposite to diffusion layer (active layer) 1004.

FIG. 32 is an example of the ejection correction from an active region. Although a design layout is a rectangle layout as shown in FIG. 32A, when pattern transfer is actually performed, a pattern end will constitute form which is round like FIG. 32B according to effects, such as diffraction of exposing light, and acid diffusion of resist. When this round part reaches an active region, transistor characteristics will deteriorate according to phenomena, such as a punch-through. Then, ejection much more than a fixed quantity must be secured. As shown in FIG. 32C, the variables in this case were made the hammer head of width h3 and length h4 at the gate end. These variables were adjusted using the above-mentioned genetic algorithm technique.

[Contact Layer]

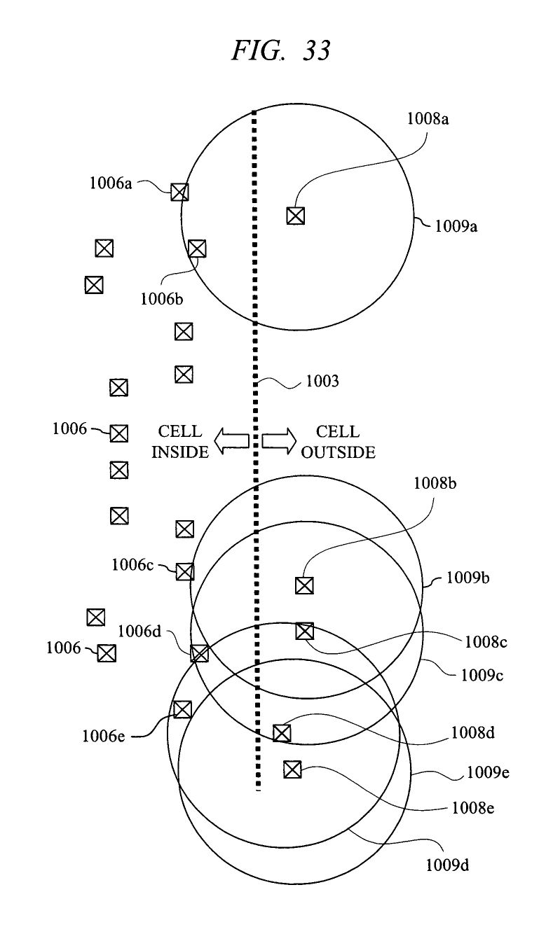

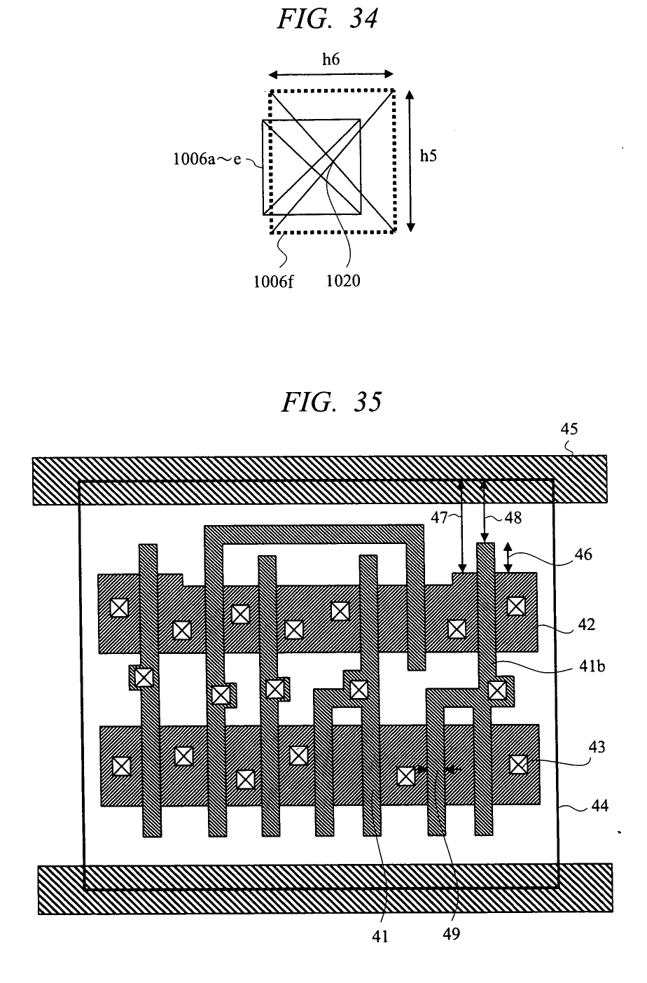

The sample layout of a contact layer is shown in FIG. 33. The patterns which re-correct OPC in response to the influence of an external cell are patterns concerning interaction regions 1009a-e from patterns 1008a-e of an external cell, and are shown by 1006a-e in the drawing. The radius of this interaction region is about 2 λ/NA, although it is dependent on an acid diffusion constant, standard dimensional accuracy, etc. of resist. As shown in FIG. 34, the variables of this pattern 1006f to which re-OPC is applied are height h5 and width h6, and, also in the centre position 1020, correction of position drift is also performed as a variable. These variables were adjusted using the above-mentioned genetic algorithm technique.

### Embodiment 4

Embodiment 4 of the present invention is explained using FIGS. 35-38. FIG. 35 is an example of a certain standard cell, and 44 is a cell boundary. 41 is the gate wiring comprising a gate, 42 is a diffusion layer, and 43 is a contact hole.

Although it is gate length 49 for a gate that dimensional accuracy is required most, except for gate pattern 41b close to a peripheral portion, it is hard to receive the proximity effect of another cell or a pattern arranged around a cell. As the reason for this, in addition to distance with an external pattern being separated, it is also large to be based on the spatial relationship that the gate is running perpendicularly and the pattern arranged at the upper and lower sides of the gate and the gate length which is the width of a horizontal direction cannot cause an interaction easily. With the pattern arranged in the horizontal direction, except gate pattern 41b arranged at the place nearest to a peripheral part, where spatial relationship is already decided, OPC processing is done. Gate pattern 41b arranged at the place nearest to a peripheral part becomes a kind of breakwater, to reduce the influence of the proximity portion from the outside. Especially, the gate pattern 41b is a breakwater of the acid diffusion of resist with a wide range where influence reaches. The gate pattern 41b of an outermost periphery portion also touches a cell boundary on both sides of the diffusion layer including contact, and the influence from a cell external pattern is comparatively small.

Pattern deformation of the gate wiring inserted between diffusion layers 42 is next important. Since the complicated wiring arrangement comprising connection with contact is required for this and it is wounded or bended intricately, OPC also with this complicated is needed. Since this portion is distantly separated from cell boundary 44, OPC will be completed once the pattern proximity effect correction in a cell is applied.

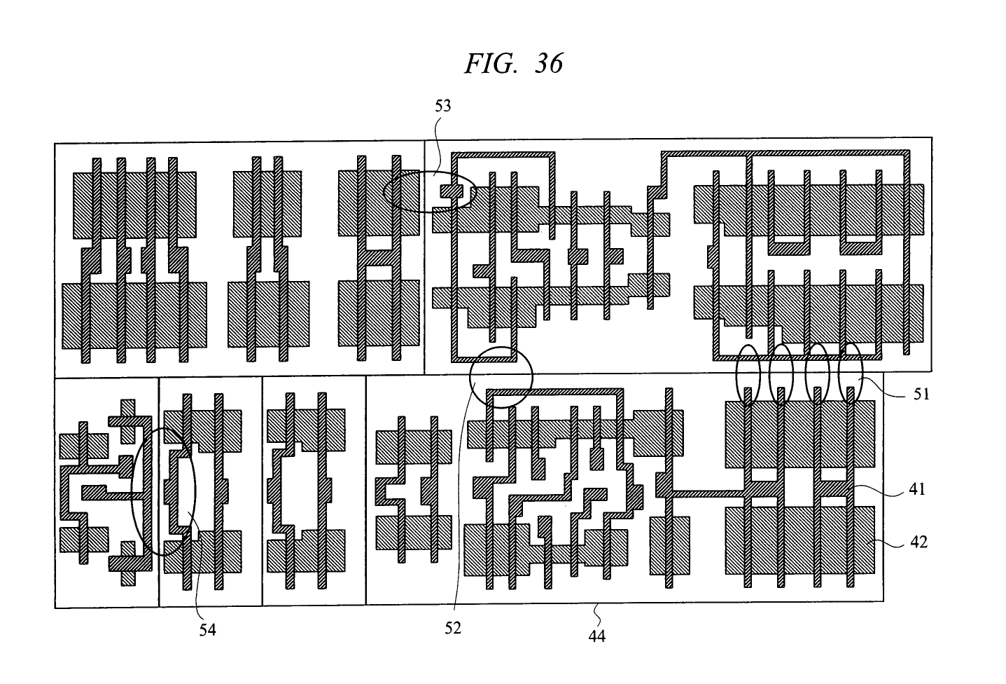

The process for preventing the pattern deformation near the cell boundary 44 is next important. As shown in FIG. 36 which is a layout pattern in which some cells have been arranged, the pattern deformation accompanying proximity between cells takes place at opposite portion 51 of a wiring end, and the wiring which opposes perpendicularly, opposite portion 52 between parallel wirings, opposite portion 53 that approaches and faces with the gate on a diffusion layer, opposite portion 54 which a polygonal wiring approaches and faces, etc. Even if OPC when a cell exists independently is applied to the pattern, at such a place, pattern deformation occurs with proximity between cells, and problems that a pattern is disconnected, patterns contact with each other, a doubling margin with the pattern of other layers cannot be taken since meandering and a position shift are happened, etc. occur. As a result, yield lowering of LSI is caused.

Generally, at the upper and lower sides of a cell, there is arranged a region 45 which fixes substrate potential, does electric isolation which prevents the cross talk between cells, or in which the power supply line which supplies a power runs as shown in FIG. 35. For this reason, some distance 47 of cell boundary 44 and diffusion layer 42 can be taken. That is, some distance 48 between cell boundary 44 and end portion of a gate wiring and a wiring arrangement portion can be taken. For this reason, even if it does not perform big re-OPC correction to the pattern of the circumference by re-OPC in this neighborhood, pattern deformation can be contained in a desired deformation range. Extremely strict or high dimensional accuracy like the gate on a diffusion layer is not demanded to the pattern of this region. Since the gate on a diffusion layer influences transistor characteristics greatly, the strict dimensional accuracy like ±5%, for example is required, but the dimensional accuracy standard of the pattern near a cell boundary part is loose like ±20%, for example. When there are not disconnection, or contact with a contiguity pattern depending on the case, suppose that it is good. This is based on the difference of a function.

From the above-mentioned thing, OPC when a cell is placed independently was performed to the pattern of the whole cell surface, and they were registered in the library. Then, the cell and the pattern have been arranged and pattern OPC re-correction processing near the cell boundary neighborhood in consideration of the influence of other cell patterns arranged to the circumference of the cell was performed.

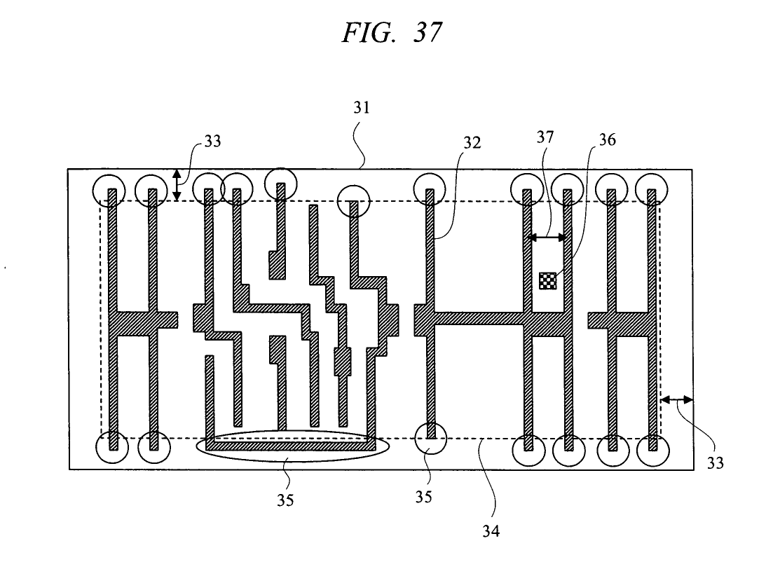

The adjustment object at this time is shown in FIG. 37. In the case of the gate wiring pattern, although, as for pattern 32, a layer is not especially specified, distance 33 which this influence attains to turned out to be P as a result of performing various analyses, making the measure the minimum pattern pitch P that faces across contact hole 36.

Since the influence of a pattern or other cells which have been arranged around a cell by the inside of region 34 as mentioned above cannot reach easily, the pattern deformation by a proximity effect takes place by mutual interference of the patterns in cell 31. Then, pattern deformation when the cell has been arranged independently was first corrected by the usual OPC technique, they were registered into a library, and when the same cell as this was used, it was referred to. Not only this product but in the case of other products in which this cell is used, the cell which performed this OPC correction was referred to.

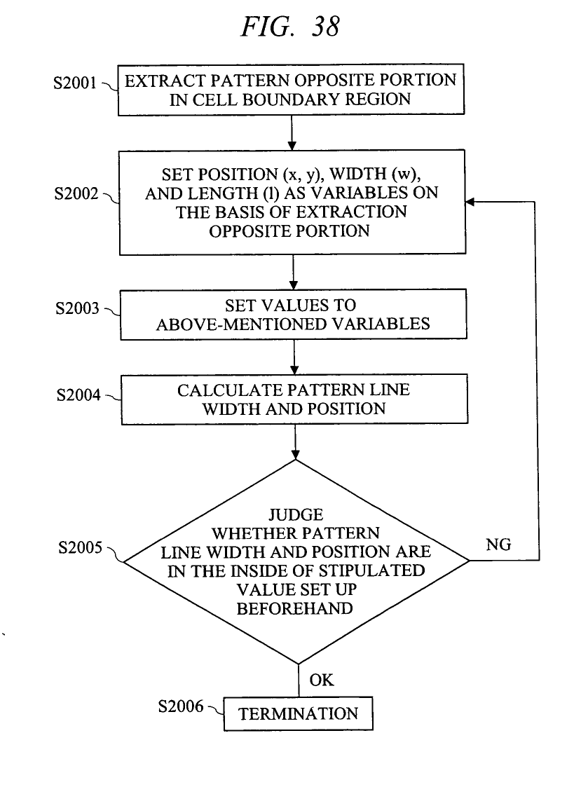

And next, OPC re-correction was performed for pattern 35 in the region between 31 and 34 in consideration of the influence of the pattern which adjoins the cell. The procedure is shown in FIG. 38. First, the pattern opposite portion in a cell boundary region is extracted (Step S2001). A cell boundary region is 33 of FIG. 37, and opposite portions are 51-54 of FIG. 36. And a position (x, y), width (w), and length (l) are set as a variable on the basis of the opposite portions (Step S2002), a value is put into the above-mentioned variable (Step S2003), and the simulation of the line width and position of a pattern is done (Step S2004). It is judged whether the result is in the inside of the stipulated value set up beforehand (Step S2005), and if it is in the stipulated value, it ends by making the value into a re-OPC correction value (Step S2006). If it is outside the stipulated value, the variable value is reset, and the simulation is performed again.

This method enabled to apply OPC at higher speed by about single figure or one tenths than a conventional method to the whole chip surface. It is not necessary to apply re-OPC to all the patterns used as the above-mentioned object, but it is also possible to omit re-OPC processing depending on the function and required precision of the pattern.

### Embodiment 5

Here, the example of re-OPC when using genetic algorithm to a concrete pattern is shown.

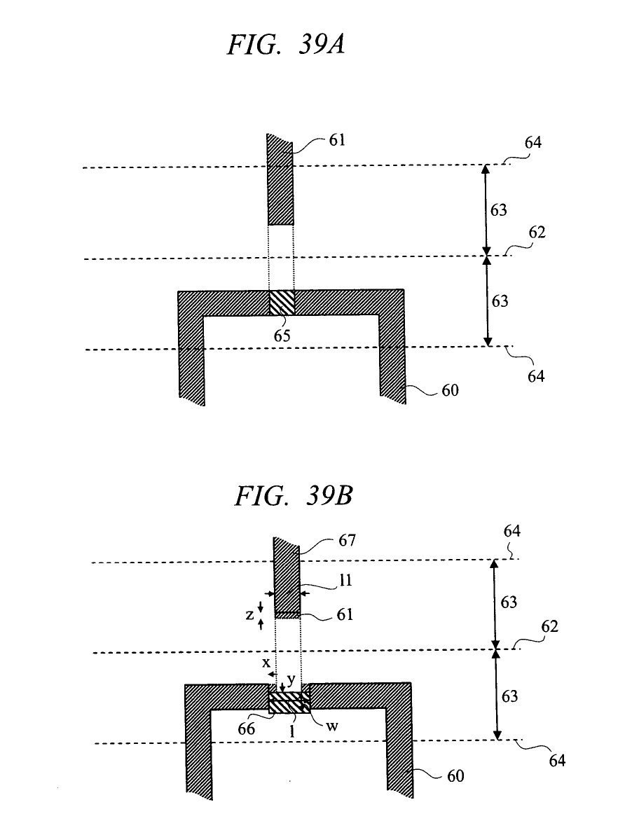

Since the calculation procedure of genetic algorithm is as having described in the above “Summary of the Invention”, the detail of each step is explained here. First, the case where main part patterns 60 and 61 face perpendicularly across cell boundary 62 as shown in FIGS. 39A and 39B is explained. 63 is width of re-OPC correction object domain, and in the case of gate wiring, it is P as shown in Embodiment 4. 64 is the borderline. The re-OPC portion is an opposite portion 65 in re-OPC correction object domain 63, and the variables are a position (x, y) from base point of an opposite portion, pattern width w, pattern length l, and the amount z of ejection (the amount of withdrawals) of the pattern of an opposite portion that faces across a cell boundary. The adjustment result becomes 66 and 67.

“Initialization: Definition of Chromosome Expression”

In Embodiment 5, each variable is treated as the real number which shows the size of a figure directly. Above-mentioned position (x, y), pattern width w, pattern length l, and the amount z of ejection (the amount of withdrawals) constitute variables. However, since it is hard to deal with those in these character forms, they are expressed with qi (i=1, 2, - - - , 5), and are made to correspond to q1=x, q2=y, q3=w, q4=l, and q5=z. At this time, it is also possible to do gene expression of not the value of the size itself but the difference from a design objective. Real value expression of each element qi of variable vector Q may not be done, but n-ary number expression using a notation system of base n may be done by deciding a upper limit, a lower limit, and the number of quantization steps.

When the same cells, such as a memory, are used, arranging repeatedly regularly, optimum value search is not performed for all the variable vectors of all the cells, but grouping can be done, the length of a chromosome can be reduced and optimization can be made easy. For example, when it is assumed in FIG. 18 that all the cells are formed in a figure pattern of the same kind, and the figure is a bilateral symmetry and up-and-down symmetry, all of the variable vector of all the cells may not be made applicable to optimization. By classifying into four kinds from Type A to D, optimizing only the variable vector (Q1 Q2 - - - Q4) which defines figures of four cells, and applying the result to all the cells according to their type, the effect same with having adjusted the whole mask can be acquired.

For example, in FIG. 18, as for cell 81, five cells of an upside and left-hand side do not exist among the cells of the eight circumferences, but three cells, 82, 83, and 84, of right-hand side and the bottom exist. As for cell 90 bilaterally symmetrically, and as for cell 87 up-and-down symmetrically, the relation with surrounding cells (89, 92, 91, and 88, 85, 86) are the same as that of cell 81. Therefore, the result of optimization of cell 81 can be used also for cell 90 or cell 87. Thus, the adjustment process of optimization can be skipped.

“Initialization: Determination of Evaluation Function”

Since an explicit function cannot define fitness, the procedure of the fitness calculation which includes the four following steps is adopted.

Step (1): Reconstruct a figure pattern using the variable vector which becomes settled uniquely from a chromosome.

Step (2): Perform an optical simulation and calculate an exposure pattern. Since a resist pattern can be predicted more accurately by carrying out together the simulation of acid diffusion, the accuracy of optimization can be improved.

Step (3): About the calculated exposure pattern, measure the length, the width, and the position of a pattern and calculate an error with a designed value. Usually, as an index, although the simple sum of the error is used, weight can also be attached. When attaching weight, width w is usually made heavy. It is because width is an element with a high occurrence ratio of disconnection and a short circuit. As other methods of the method of calculating the sum, there is also the method of calculating whether there are disconnection, and contact with a contiguity pattern. A contiguity pattern may also have a case of another layer, and the doubling margin value of standard and the dimensional accuracy value of standard shall be added to the design size and design position of the pattern in this case. The following describes the method calculating the sum.

Step (4): Since a target here is obtaining the exposure pattern which is infinitely close to a designed value, it is so good that an error is small. Then, the reciprocal of the sum of the measured error is made into fitness. Although the reciprocal of the sum with error was adopted as fitness here, it is good also considering the subtraction value from the constant decided beforehand as fitness.

“Generation of Initialization: Initial-Chromosomes Group”

Let the vector which includes four real value elements here be a chromosome according to the rule decided in the above “Initialization: Definition of Chromosome Expression”. Chromosome number N is set to 100 and 100 chromosomes are generated at random using a pseudorandom-numbers generator. In order to improve search speed, it may start from the initial group which applied minute perturbation to the result corrected with model base OPC.

“Evaluation of Chromosome”

According to the evaluation procedure of a chromosome decided in the above “Initialization: Determination of Evaluation Function”, all the chromosomes are evaluated and fitness is calculated.

“Generation of Next-Generation Group: Selection”

Roulette selection is used in Embodiment 5. This is a system which proportions the probability that each chromosome can survive in the next generation in fitness. That is, when fitness is high, the arrangement on roulette will increase so much and the probability when turning roulette of hitting will become large. Concretely, when a chromosome group's size is set to N, fitness of the i-th chromosome is set to Fi and total of the fitness of all the chromosomes is set to Σ, it realizes by repeating the procedure which extracts each chromosome with the probability of (Fi/Σ) N times. Since a chromosome number is 100 in the above-mentioned case, 100 next-generation chromosomes will be chosen by repeating 100 times. Crossing-over systems, such as a tournament choice method and a rank choice method, or alternation-of-generations models, such as a MGG (Minimal Generation Gap) system, may be used (References: Sato et al., “the proposal and evaluation of an alternation-of-generations model in genetic algorithm”, Japanese Society for Artificial Intelligence, Vol. 12, No. 5, 1997).

“Generation of Next-Generation Group: Crossing-Over”

Uniform crossing-over is used in Embodiment 5. This selects two chromosomes out of each chromosome group, and is the method of determining at random whether exchange the variable which is a gene, in each genetic locus. Two selected chromosomes are concretely made into Q¹=(q¹₁, q¹₂) and Q²=(q²₁, q²₂), respectively, and random number generation which outputs 0 or 1 with one half of probability is performed twice. The first random number is against the first genetic locus, when becoming one, it will exchange x¹₁ and x²₁, and when becoming zero, it will not exchange them. The processing to the second genetic locus is also the same. In addition, the genetic locus chosen at random may not be exchanged, but the value acquired by doing a weighted mean may be used.

UNDX (Unimodal Normal Distribution Crossover) and Simplex Crossing-over which are the crossing-over systems developed for the chromosome in which real value expression was done in order to improve search speed and accuracy, EDX (Extrapolation-directed Crossover) etc. may be used (References: Sakuma et al., “Optimization of the nonlinear function by real value GA: the problem in the formation of high dimension of search space, and its solution”, the 15th Japanese Society for Artificial Intelligence National Conference, the 2nd A.I. Meeting of Youngman, MYCOM2001, 2001).

When expressing a chromosome by a binary vector, multipoint crossing-over can also be used except for uniform crossing-over.

“Generation of Next-Generation Group: Mutation”

In Embodiment 5, the processing which adds the random number generated according to the normal distribution is adopted to the genetic locus selected by mutation rate P_{M} according to uniform distribution. Here, it was set as mutation rate P_{M}=1/50, average u=0 of a normal distribution, and standard deviation σ=5×10ˆ9.

“Terminating Condition of Search”

When an error with a designed value becomes 0 or less than or equal to a constant value, or when the number of times of evaluation of a chromosome becomes beyond constant value, search is terminated. In Embodiment 5, when an error with a designed value became 0, or when evaluation of a chromosome was performed 5000 times, it decided to end search. The mutation using the random number generated according to a normal distribution is used. In order to improve search speed and accuracy, the Adaptive Mutation method in which the improvement speed of the fitness of the whole group is supervised and a mutation rate is increased temporarily when it does not improve beyond fixed time may be used together.

Although the above is explanation of the genetic algorithm used in Embodiment 5, search speed and accuracy can be improved by using together other search techniques, such as the climbing-a-mountain method, the simplex method, a steepest descent method, the annealing method, and a dynamic programming method. By using other blind search techniques or probabilistic search techniques, such as evolution strategy (Evolution Strategy; ES) or genetic programming (Genetic Programming; GP) besides genetic algorithm, properly, much more improvement in search speed and improvement in accuracy are realizable.

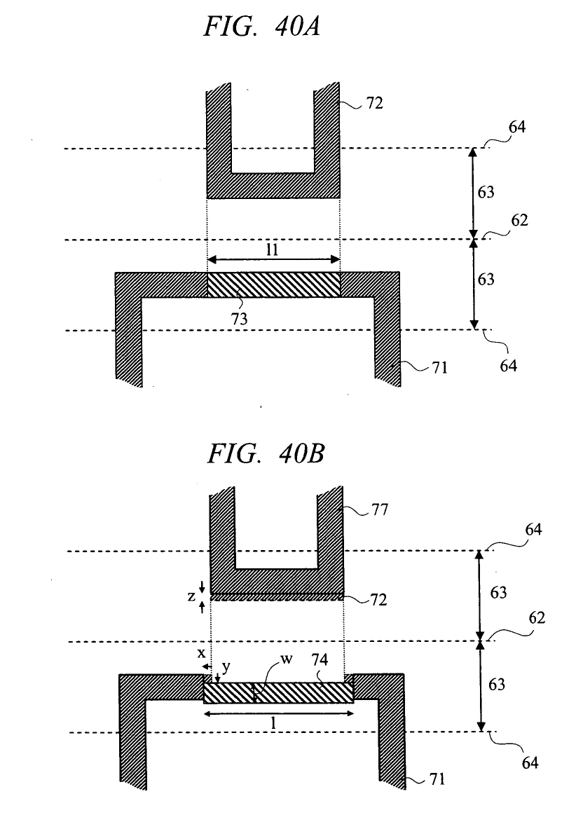

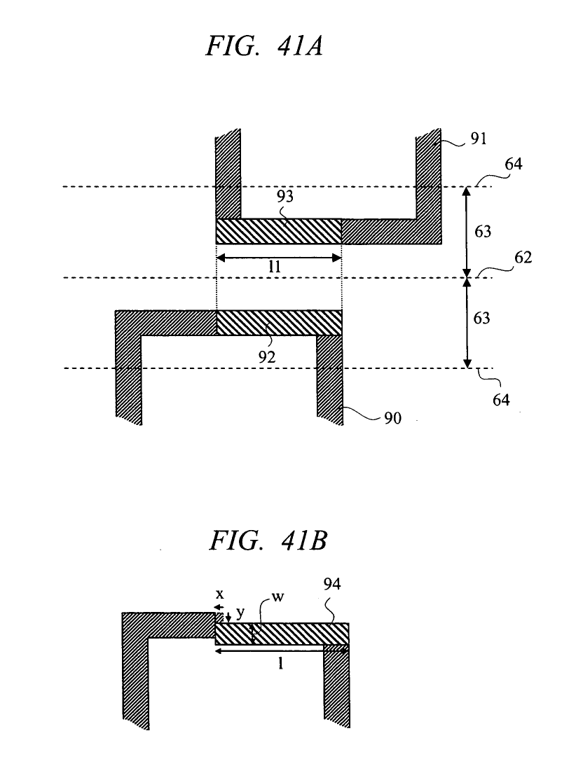

The above showed the OPC readjusting method of a pattern end portion, and a wiring perpendicular to it. Similarly, to the case with which a pattern is mutually parallel in cell boundary region 63 as shown in FIGS. 40A and 40B, and the case with which a pattern is mutually parallel with an inconsistency region as shown in FIGS. 41A and 41B, the above-mentioned method is applied. Namely, regions 73, and 92, 93 which face with width l₁ are extracted in cell boundary region 63. The position (x, y) on the basis of the extracted portion, width w, and length l, and amount z of ejection (the amount of withdrawals) of the pattern of the opposite portion which faces across a cell boundary are made into variables, and the above-mentioned method is applied hereafter.

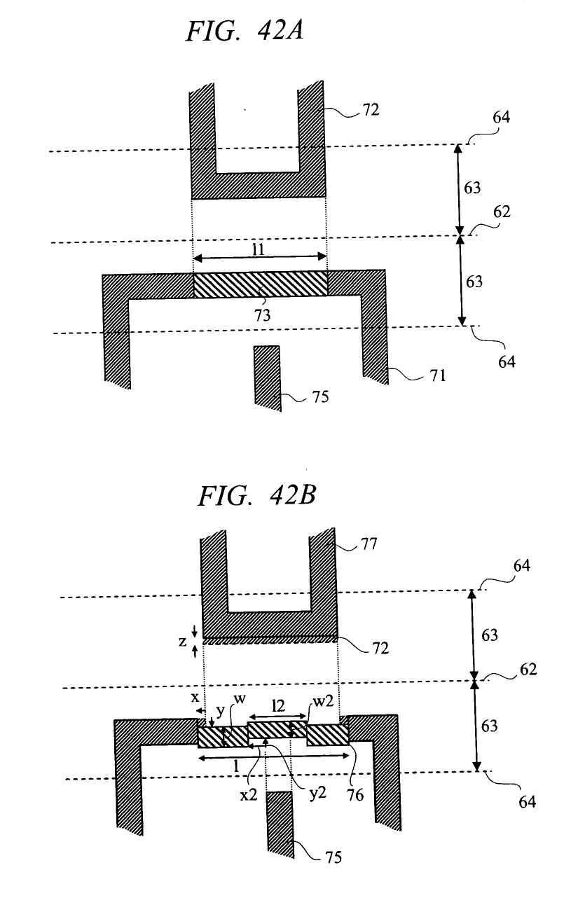

As shown in FIGS. 42A and 42B, in order to avoid that there is contiguity pattern 75, and the contiguity pattern 75 is influenced greatly and a re-OPC region is expanded like a dominoes knocking down game by applying re-OPC correction to pattern 71, a position (x₂, y₂), width w₂, and length l₂ are also added as variables on the basis of the opposite portion of pattern 75 (FIG. 42B). Thus, when there are many contiguity patterns which affect OPC, variables will increase, but the genetic algorithm technique is suitable for parallel processing, and it becomes possible to drive into an optimum value at high speed. Since the pattern in region 63 has some allowance which was described in Embodiment 4, such adjustment is possible.

In the above, since a semiconductor chip is created using the cell library which was performed OPC processing beforehand, and the influence of a surrounding cell library is optimized using the genetic algorithm in which high speed processing is possible, processing time shortening by a single figure or less was attained compared with the conventional method of performing OPC processing to all the patterns.

### Embodiment 6

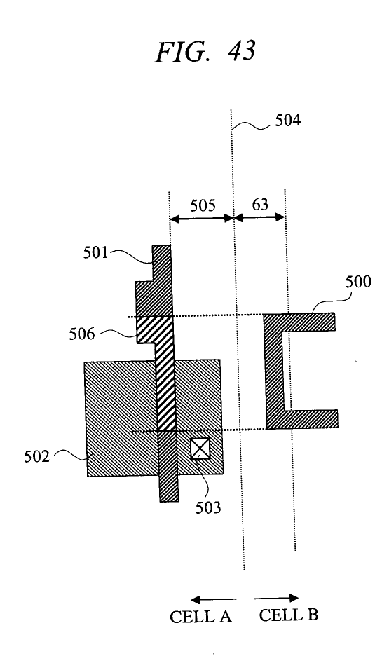

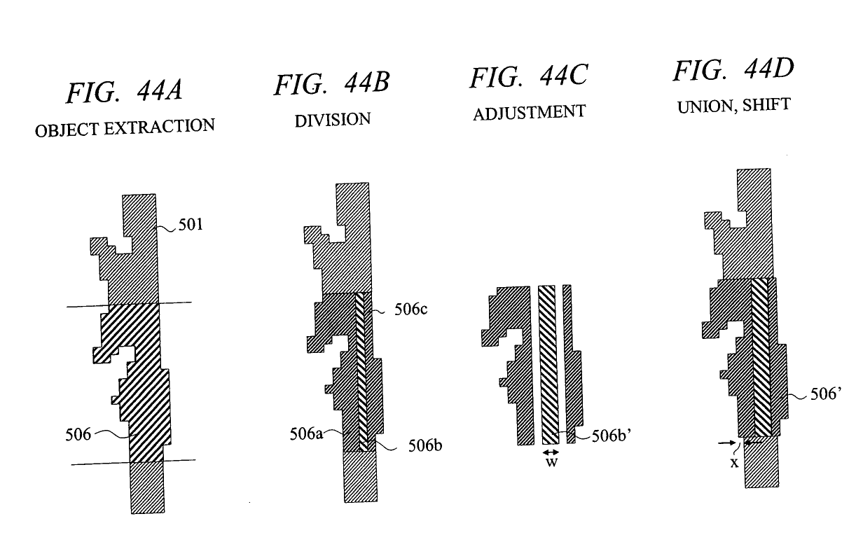

Embodiment 6 of the present invention is explained using FIG. 43 and FIGS. 44A to 44D. Across cell boundary 504, FIG. 43 is a drawing where gate pattern 501 on diffusion layer 502 has faced with gate wiring pattern 500 of the next cell, and shows the opposite portion by 506.

Since distance 505 of cell boundary 504 and the gate pattern 501 has a boundary of diffusion layer 502 which faced across contact hole 503 between them, the distance is comparatively large from a doubling margin, an electrical property, the processing margin on isolation formation, etc. Although readjustment of the proximity effect correction by the existence of a proximity pattern was needed from it being a gate on a diffusion layer where close dimensional accuracy is demanded extremely, this readjustment was possible by sizing, so-called width adjustment. Since the pad for taking contact with a connecting hole good is formed in gate pattern 501, as shown in FIG. 44A, complicated OPC processing is performed in the registration cell stage where it has OPC processed without a contiguity cell. This sizing which is re-OPC adjustment was performed by the following methods.

First, as shown in FIG. 44B, object portion 506 is divided into rectangle part 506b of a core, and complicated figures 506a and 506c of the right and left. And, width w of rectangle part 506b is made into a variable as shown in FIG. 44C, the simulation of figure 506′ which is formed by uniting figures including the rectangle part as shown in FIG. 44D is done, and the line width and position are driven in the fiducial point set up beforehand by the method shown in Embodiment 5. Or position shift x is added to a variable and it drives in. Thus, desired OPC correction was able to be performed at high speed by simple processing also to the pattern to which OPC processing was done and which included the complicated polygon.

### Embodiment 7

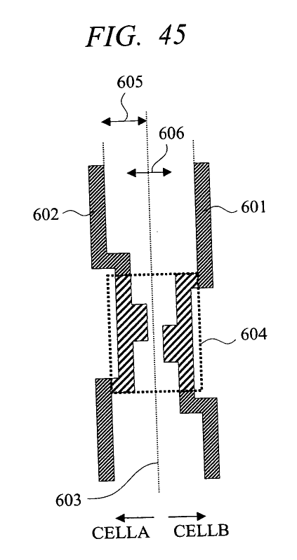

Embodiment 7 of the present invention is explained using FIG. 45. FIG. 45 shows the case where patterns 601, 602 of two cells are close across cell boundary 603 in region 606 (it will be called a proximity boundary region) still narrower than cell boundary region 605 described in Embodiment 5.

The width of region 606 is more than or equal to pattern minimum interval L of the layer, and less than or equal to 2 L. Patterns 601, 602 constitute polygonal figures in the proximity part. This is because the pad with a connecting hole is arranged, and this arrangement is occasionally observed at the left part or the right part of a cell. Even if there is a doubling drift, in order to take contact with a connecting hole sufficiently, reservation of the width and length of a pattern is important, and each must not contact.

The OPC method of this pattern is shown below. First, in the state of cell independent arrangement, where this portion is included, OPC is applied by the usual method, and it is registered in the cell library. Then, for OPC re-correction of this portion, portion 604 which faces in cell boundary region 605 was extracted, and OPC was again applied to the portion by the usual method. In this case, although the genetic algorithm technique was not used, since the things to which cell library registration was done were used by appropriation about OPC of most patterns, the OPC processing time in the whole chip became short.

### Embodiment 8

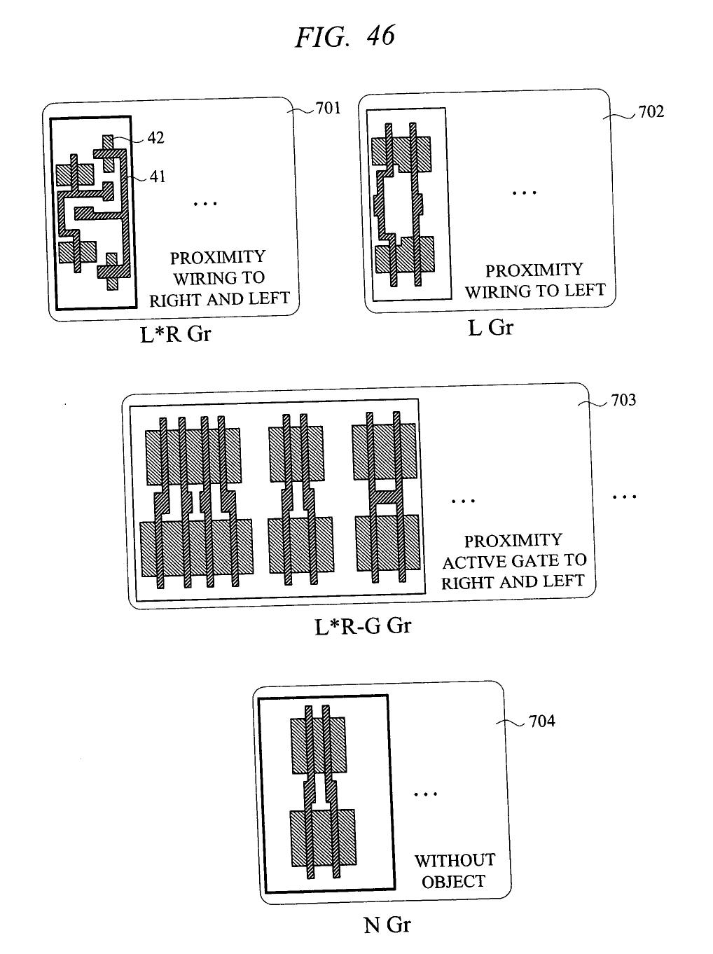

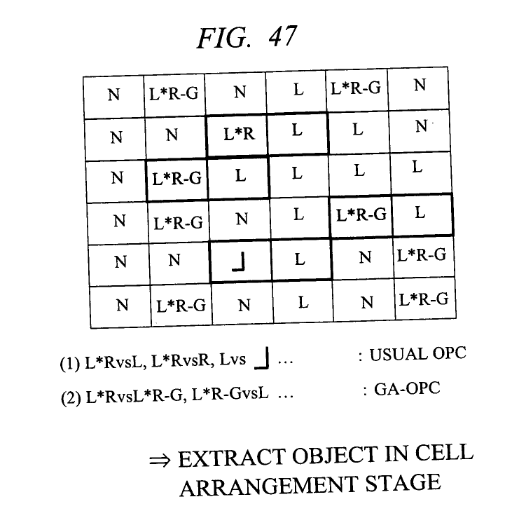

How to raise processing speed further by doing marking of the cell which has a pattern in the proximity boundary region (width L) described by Embodiment 7, judging whether there is this kind of super-proximity pattern in a cell stage, or there is nothing, simply extracting only a portion where there is one, and performing re-OPC processing, is explained below using FIG. 46 and FIG. 47. L is the minimum gap between patterns permitted by the layer.

First, as shown in FIG. 46, the cell in which the left part and right part of the cell have a pattern in a proximity boundary region is registered, for example as L*R group 701 in the cell stage. Similarly, the cell which has a pattern in a proximity boundary region at the left part of a cell similarly is registered as L group 702, and the cell which has a pattern in a proximity boundary region at the right part of a cell is registered as for example, an R group (not shown). The cell in which the active gate which was shown by Embodiment 7, and which was formed on the diffusion layer is arranged from the cell boundary at the place of the distance less than or equal to 4.5 L is extracted. When it is in both the left part and right part of a cell, it is registered as L*R-G group 703, and the case where it is only in the left part of a cell is registered as an L-G group, and the case where it is only in the right part of a cell is registered as an R-G group (latter 2 cases are not shown). The case of not being applied to above any case is registered, for example as N group 704.

Next, in the stage where the cell and the pattern have been arranged, as shown in FIG. 47, rotation, reversal arrangement, etc. of a cell are taken into consideration. It is investigated whether the cell and pattern which had a pattern in the proximity boundary region at right and left of a cell boundary come, or the cell of L*R-G, L-G, or R-G registration comes, and processing of Embodiment 6 or Embodiment 7 is performed narrowing down to the portion of the arrangement. By this method, processing manday could be reduced and further OPC time reduction was able to be aimed at.

### Embodiment 9

A system LSI with an SRAM portion and a logical circuit portion was manufactured using the mask pattern generation method described in Embodiments 4-8. The minimum gate width of the system LSI is 40 nm, and the minimum pitch is 160 nm. A logic circuit section allows an arbitrary pitch wiring, and any arrangement limitation other than a minimum interval is not formed between cells, either. For this reason, IP from the former is inheritable, the deployment nature as a platform is high, and it constitutes a layout rule applicable to multiple kinds.

When the correction pattern of this size is created by rule base OPC, partial variation will occur in the gate pattern size in an active region. For example, narrowing and fattening are generated in the portion of a bottom near a pad, and these were degrading the device characteristics. There were few exposure margins to exposure change or focus fluctuation, and there was a problem that the yield as a semiconductor device was low. Further, when the mask making pattern was generated with commercial model base OPC, it took the long time of seven days.

System LSI is specific user-oriented products, its product cycle is short, and it is needed to manufacture for a short period of time. The period is a lifeline and not only the value as a device but the marketability of the product incorporating it is influenced. When it processes preferentially by a sheet process, a wafer process period is two weeks at the shortest, and mask supply becomes quick. In order to realize a formation period of a practical mask making pattern, such as one day, conventionally, the rule base had to be applied partially and problems, such as lowering of the yield, were caused as mentioned above.

By applying a mask pattern generation method described in Embodiment 1, the time required for forming mask pattern is one day, and yet device characteristics and the yield equivalent to having applied the model base completely were able to be obtained. By applying a sheet process to a wafer process, wafer process waiting time could be reduced and the effect that a rate of feeding mask could be balanced and the shipment timing of a system LSI became early was acquired.

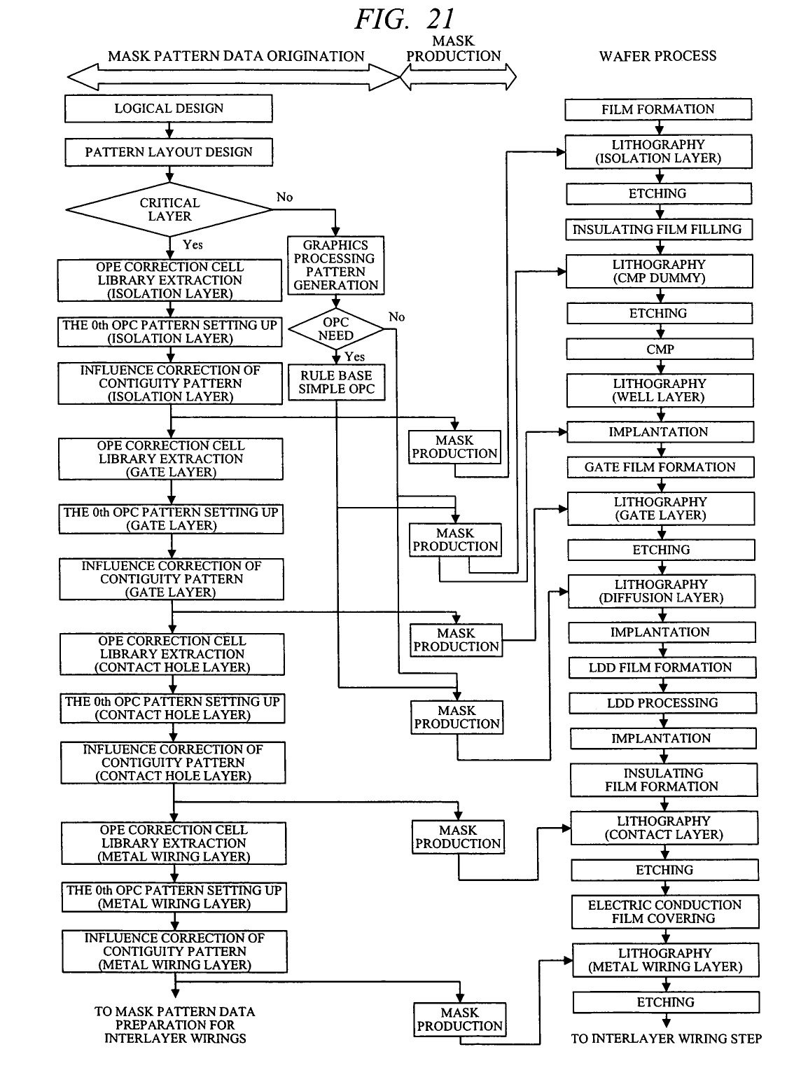

Explanation is added quoting FIG. 21 for the above thing. FIG. 21 shows the mask pattern data preparation, mask production, and the wafer process step of a system LSI in the form of a flow chart. A mask pattern data preparation step is shown in left-hand side, and mask production is shown in the center, and a wafer process step and timing are shown in right-hand side.

After finishing a pattern layout design based on a logical design, manufacture of LSI starts. As a wafer process flow, following film formation, lithography, etching, and an insulating film filling for making isolation (separation between active regions), and the lithography, etching and CMP for CMP dummy pattern production for doing flattening more, isolation is formed. The lithography for implantation striking separation and implantation are performed after that, a well layer is formed, the film formation for gates, lithography, etching, the lithography for implantation striking separation, implantation, the film formation for LDD, LDD processing, and implantation are performed, and a gate is formed. After that, a conduction hole is opened forming an insulating film and performing lithography and etching for contact holes, and a wiring layer is formed performing lithography and etching after forming an electric conduction film. After that, although it is not shown, the interlayer wiring is formed by formation of an interlayer insulation film, formation of an opening, covering of an electric conduction film, and CMP.

It is necessary to prepare a mask so that it may correspond to this wafer process flow. Masks are divided roughly into two objects including an object for critical layers which needs dimensional accuracy, and another object for non critical layers, and the former needs OPC with the huge amount of data. Simplified OPC, mere figure operation, or the data itself is enough for the latter. The representatives of a critical layer are isolation, a gate, contact, and the first and the second wirings.

Mask pattern OPC data enters into production procedures after judging whether it is a critical layer or not, first. At first, the first required preparation for isolation is made. What suits is extracted from the cell library for OPE (optical Proximity Effect) correction already made, and the 0th OPC finished pattern is set up combining those patterns. And, by doing correction in consideration of the influence of contiguity pattern is performed based on the genetic algorithm technique of Embodiment 1, a final OPC pattern is made, and a mask is produced based on the data.

Next, the pattern data and the mask of the gate layer, the contact layer, and the wiring layer are prepared by the same technique as above. Although the procedure of preparing each layer in series was shown here, it may prepare in parallel. However, when in parallel, a plurality of systems for data generation are needed, and big equipment is needed. When it can process in series and the processing speed suits wafer process processing timely, there is a merit that a system can be miniaturized. Mask pattern data is prepared for a non critical layer using another pass as mentioned above.

Since the isolation layer which is a critical layer is a layer of positioning, when the mask preparation is overdue, it will link with it being late also in wafer outgo directly. For this reason, completion period of the mask pattern data of an isolation layer is very important. In this embodiment, even if united with mask production, it could prepare in one day, and it has been halved compared with two days of usual technique.

Until the following lithography for gate layers, it will take 9 steps by the process number in this main class, and it will take about 50 steps (not shown) if detailed steps, such as washing are included, but when it processes by a sheet process, it can process in two days. When the mask for gate layers is not prepared in the meantime, the loss by standby will occur. Since close dimensional accuracy is extremely required of a gate, mask drawing and inspection take the time of about one day. In Embodiment 9, preparation of mask pattern data was possible in one day. In the conventional method, it took 7 days. In the 7 days, even if it enlarges pattern data generation equipment and begins data generation in parallel to preparation of isolation pattern, it will not catch up with the speed of wafer processing. By this method, with comparatively small pattern data generation equipment, high-speed processing suitable for the speed of a wafer process of sheet process was completed, and the system LSI was able to be manufactured at an early stage.

Since dimensional accuracy is required of a gate pattern, in a rule base, it is difficult for it to fully secure device characteristics. However, with a model base, since it becomes complicated processing, the problem that pattern generation takes great time is stronger than other layers. For this reason, this method was effective especially in preparation of gate pattern.

Since conventional OPC processing was performed to all figures of the mask which define the circuit pattern of a semiconductor chip, there was a fault that processing time was huge according to increase of the number of figures accompanying microfabrication. However, according to the above-mentioned present invention, processing time is substantially reducible by performing OPC processing first per cell, being saved, forming all figures of a mask from combination of this saved cell, and performing OPC regulated treatment between cells in all figures of this mask.

When OPC processing of a cell unit is beforehand held as a library and share usage is done between products, since the OPC processing between cell units becomes main substantially about the OPC processing time for every product, as compared with the case where it carries out to all figures of a mask, the number of combination (the number of parameters) decreases substantially, therefore the convergence time to these optimization also decreases substantially.

When using the mask pattern designing method and designing device in optical proximity correction of optical lithography of the present invention, the mask pattern design of the large-scale integrated circuit in the manufacturing method of a semiconductor device will be made at high speed and easy. Therefore, since a mask pattern can be made cheaply and early, a large-scale integrated circuit can be manufactured efficiently. There are also few generations of failure by disconnection etc. of the manufactured large-scale integrated circuit, therefore its reliability is improved, and the yield is also improved. It is effective in being able to aim at cost reduction of the custom IC using a mask pattern in large quantities etc., and expanding an industrial applicable field by shortening the design time of a mask pattern by about one figure than conventional case. For example, it can deal with to development of the system LSI towards digital information appliances of limited production with a wide variety by low cost.

In the foregoing, the present invention accomplished by the inventor is concretely explained based on above embodiments, but the present invention is not limited to the above embodiments, but variations and modifications may be made, of course, in various ways in the scope that does not deviate from the gist of the invention.

The present invention is available in the manufacturing industries, such as a semiconductor device and an electronic apparatus.

1. A mask pattern design method, comprising the steps of:
(a) performing first proximity effect correction accompanying pattern transfer formation when a cell is arranged independently, and registering the cell group into a cell library;
(b) arranging a plurality of cells using the cell library; and
(c) performing second proximity effect correction that corrects a pattern deformation generated by an interaction between patterns by approaching and arranging the cells;
wherein, in the step (c), a pattern deformation adjustment portion accompanying proximity between cells is a pattern opposite portion in a cell boundary region specified beforehand.

2. A mask pattern design method according to claim 1, wherein:
step (b) includes arranging a plurality of cells using a cell library into which a cell group to which first proximity effect correction accompanying pattern transfer formation when a cell is arranged independently is performed is registered; and
in the step (c), a pattern deformation adjustment portion accompanying proximity between cells is a pattern opposite portion in a cell boundary region specified beforehand.

3. A mask pattern design method according to claim 1, wherein:
the step (c) includes performing second proximity effect correction that corrects a pattern deformation generated by an interaction between patterns by approaching and arranging the cells to a pattern in which a plurality of cells using a cell library into which a cell group to which first proximity effect correction accompanying pattern transfer formation when a cell is arranged independently is performed is registered are arranged; and
a pattern deformation adjustment portion accompanying proximity between cells is a pattern opposite portion in a cell boundary region specified beforehand.

4. A mask pattern design method, comprising the steps of:
(a) performing first proximity effect correction accompanying pattern transfer formation when a cell is arranged independently, and registering the cell group into a cell library;
(b) arranging a plurality of cells using the cell library; and
(c) performing second proximity effect correction that corrects a pattern deformation generated by an interaction between patterns by approaching and arranging the cells;
wherein, in the step (c), a pattern opposite portion in a cell boundary region specified beforehand is extracted, and a pattern deformation adjustment accompanying proximity between cells is made.

5. A mask pattern design method according to claim 4, wherein:,
the step (b) includes arranging a plurality of cells using a cell library into which a cell group to which first proximity effect correction accompanying pattern transfer formation when a cell is arranged independently is performed is registered; and
in the step (c), a pattern opposite portion in a cell boundary region specified beforehand is extracted, and a pattern deformation adjustment accompanying proximity between cells is made.

6. A mask pattern design method according to claim 4, wherein:
the step (c) includes performing second proximity effect correction that corrects a pattern deformation generated by an interaction between patterns by approaching and arranging the cells to a pattern in which a plurality of cells using a cell library into which a cell group to which first proximity effect correction accompanying pattern transfer formation when a cell is arranged independently is performed is registered are arranged; and
a pattern opposite portion in a cell boundary region specified beforehand is extracted, and a pattern deformation adjustment accompanying proximity between cells is made.

7. A mask pattern design method according to claim 1, wherein
a width of the cell boundary region is a minimum wiring interval which sandwiches a conduction hole in between.

8. A mask pattern design method according to claim 1, wherein
a pattern deformation adjustment portion is a pattern opposite portion between the cells, and the second proximity effect correction is performed by making a width, a length, and a position of the pattern opposite portion into variables.

9. A mask pattern design method according to claim 1, wherein
a pattern deformation adjustment portion is a pattern opposite portion between the cells, and the second proximity effect correction is performed by making the pattern opposite portion into a polygon.

10. A mask pattern design method according to claim 1, wherein
a pattern deformation adjustment portion is a pattern opposite portion between the cells, and the second proximity effect correction is performed by adjusting a width of a pattern of the pattern opposite portion by a fixed amount.

11. A mask pattern design method according to claim 1, wherein
a pattern deformation adjustment portion has a non-rectangular shape, and when a gap of a pattern which opposes of a contiguity cell is less than or equal to a gap specified beforehand, the second proximity effect correction is performed using polygonal shape to the pattern.

12. A mask pattern design method according to claim 1, wherein
genetic algorithm is used for the second proximity effect correction.

13. A manufacturing method of a semiconductor device using a mask produced by a method comprising the steps of:
(a) performing first proximity effect correction accompanying pattern transfer formation when a cell is arranged independently, and registering the cell group into a cell library;
(b) arranging a plurality of cells using the cell library; and
(c) performing second proximity effect correction that corrects a pattern deformation generated by an interaction between patterns by approaching and arranging the cells;
wherein, in the step (c), a pattern deformation adjustment portion accompanying proximity between cells is a pattern opposite portion in a cell boundary region specified beforehand.

14. A manufacturing method of a semiconductor device according to claim 13, wherein:
the step (b) includes arranging a plurality of cells using a cell library into which a cell group to which first proximity effect correction accompanying pattern transfer formation when a cell is arranged independently is performed is registered; and
in the step (c), a pattern deformation adjustment portion accompanying proximity between cells is a pattern opposite portion in a cell boundary region specified beforehand.

15. A manufacturing method of a semiconductor device according to claim 13, wherein:
the step (c) includes performing second proximity effect correction that corrects a pattern deformation generated by an interaction between patterns by approaching and arranging the cells to a pattern in which a plurality of cells using a cell library into which a cell group to which first proximity effect correction accompanying pattern transfer formation when a cell is arranged independently is performed is registered are arranged; and
a pattern deformation adjustment portion accompanying proximity between cells is a pattern opposite portion in a cell boundary region specified beforehand.

16. A manufacturing method of a semiconductor device using a mask produced by a method comprising the steps of:
(a) performing first proximity effect correction accompanying pattern transfer formation when a cell is arranged independently, and registering the cell group into a cell library;
(b) arranging a plurality of cells using the cell library; and
(c) performing second proximity effect correction that corrects a pattern deformation generated by an interaction between patterns by approaching and arranging the cells;
wherein, in the step (c), a pattern opposite portion in a cell boundary region specified beforehand is extracted, and a pattern deformation adjustment accompanying proximity between cells is made.

17. A manufacturing method of a semiconductor device according to claim 16, wherein:
the step (b) includes arranging a plurality of cells using a cell library into which a cell group to which first proximity effect correction accompanying pattern transfer formation when a cell is arranged independently is performed is registered; and
in the step (c), a pattern opposite portion in a cell boundary region specified beforehand is extracted, and a pattern deformation adjustment accompanying proximity between cells is made.

18. A manufacturing method of a semiconductor device according to claim 16, wherein:
the step (c) includes performing second proximity effect correction that corrects a pattern deformation generated by an interaction between patterns by approaching and arranging the cells to a pattern in which a plurality of cells using a cell library into which a cell group to which first proximity effect correction accompanying pattern transfer formation when a cell is arranged independently is performed is registered are arranged; and
a pattern opposite portion in a cell boundary region specified beforehand is extracted, and a pattern deformation adjustment accompanying proximity between cells is made.

19. A manufacturing method of a semiconductor device according to claim 13, wherein the pattern is a pattern of gate wiring.
